(19) United States
(12) Patent Application Publication
(10) Pub. No.: US 2013/0121122 A1
(43) Pub. Date: May 16, 2013

(54) OPTICAL INFORMATION DEVICE AND LOSS-OF-CONTROL DETECTION METHOD

(71) Applicants: Kenji Kondo, Osaka (JP); Takeharu Yamamoto, Osaka (JP); Kenji Fujiune, Osaka (JP)

(72) Inventors: Kenji Kondo, Osaka (JP); Takeharu Yamamoto, Osaka (JP); Kenji Fujiune, Osaka (JP)

(21) Appl. No.: 13/813,278

(22) PCT Filed: May 29, 2012
(86) PCT No.: PCT/JP2012/003501

§ 371 Date: Jan. 30, 2013

(30) Foreign Application Priority Data
May 30, 2011 (JP) 2011-119984

(51) Int. Cl. G11B 7/1392

(52) U.S. Cl. CPC G11B 7/13927
USPC 369/44.14

(57) ABSTRACT

Provided is an optical disc device including a focus control unit for performing control so that a convergent point of a main beam converges on a predetermined information layer, a tracking control unit for performing control so that the convergent point of the main beam scans a predetermined track or a predetermined mark sequence on an information layer, a sub beam receiving unit for receiving a sub beam reflected off the information layer and outputting a signal according to an amount of beam received, and a microcomputer for detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer.

### TECHNICAL FIELD

The present invention relates to an optical information device which records information on an information recording medium by using a light source such as a laser and a loss-of-control detection method in such an optical information device, and in particular relates to an optical information device and a loss-of-control detection method capable of detecting a loss-of-control state of optical beam spot position control on an information layer during recording operation.

### BACKGROUND ART

Conventionally, optical discs such as CDs, DVDs and BDs (Blu-ray discs) have been broadly used for the recording and reproduction of video signals and audio signals. In an optical disc device which records information on an optical disc and reproduces information from an optical disc, the processing of reading information written in the information layer of the optical disc is performed by using a minute optical beam spot, which is converged on the information layer by an optical pickup, to scan a fine track or mark sequence. In the foregoing case, in order to accurately and continuously read the information written on the optical disc, servo technology that enables the optical beam spot to follow an arbitrary position on the optical disc is essential.

Accordingly, with an optical disc device, generally speaking, performed is focus control of causing the optical beam spot to follow the focus direction relative to the information layer based on a focus error signal (hereinafter referred to as the “FE signal”) which detects a position gap between the optical beam spot and the information layer of the optical disc in a perpendicular direction (hereinafter referred to as the “focus direction”). In addition, with an optical disc device, performed is tracking control of causing the optical beam spot to follow the tracking direction relative to the track or mark sequence based on a tracking error signal (hereinafter referred to as the “TE signal”) which detects a position gap between the optical beam spot and the center of the track or the center of the mark sequence in a radial direction (hereinafter referred to as the “tracking direction”).

Moreover, proposed is an optical disc device which, during the recording operation of the optical disc device, discontinues the recording operation upon detecting a focus loss-of-control (hereinafter referred to as the “focus jump”) where the optical beam spot of the recording optical beam deviating from the intended information layer, or detecting a tracking loss-of-control (hereinafter referred to as the “track jump”) where the optical beam spot of the recording optical beam deviates from the intended radial position (for example, refer to Patent Literature 1). It is thereby possible to prevent other information from being erroneously destroyed.

With this kind of optical disc device, when the level of the FE signal exceeds a predetermined upper side threshold or a predetermined lower side threshold during the recording operation, the occurrence of a focus jump is detected and the recording operation is discontinued. Similarly, when the level of the TE signal exceeds a predetermined upper side threshold or a predetermined lower side threshold during the recording operation, the occurrence of a track jump is detected and the recording operation is discontinued. Accordingly, it is possible to prevent other information from being erroneously destroyed due to a focus jump or a track jump that occurs during the recording operation.

Meanwhile, in recent years, in response to demands of higher densification of the optical disc, proposed is an optical disc in which the number of information layers is increased, and a servo layer for controlling the position of the optical beam spot and an information layer for recording information are separated (for example, refer to Patent Literature 2). With an optical disc device that records or reproduces information to or from such highly densified optical disc, the optical beam spot of the servo optical beam is condensed on the servo layer and the optical beam spot of the recording/reproduction optical beam is condensed on the target information layer to which information is to be recorded or from which information is to be reproduced.

Here, during the recording operation, performed is focus control of the optical beam spot of the servo optical beam by using a servo layer FE signal that is generated based on the reflected light of the servo optical beam that was condensed on the servo layer. Moreover, performed is focus control of the optical beam spot of the recording optical beam by using an information layer FE signal that is generated based on the reflected light of the recording optical beam that was condensed on the information layer. In addition, performed is tracking control of using one TE signal that is generated based on the reflected light of the servo optical beam that was condensed on the servo layer and causing the two optical beam spots; namely, the servo optical beam and the recording optical beam, to simultaneously follow the tracking direction of the optical disc. Accordingly, information can be recorded at the arbitrary position of the optical disc without having to provide a plurality of servo layers.

### CITATION LIST

### Patent Literature

Patent Literature 1: Japanese Patent Application Publication No. H4-010233
Patent Literature 2: Japanese Patent Publication No. 3110532

### SUMMARY OF THE INVENTION

An object of this invention is to provide an optical information device and a loss-of-control detection method capable of preventing previously recorded information from being erroneously destroyed and preventing the mark sequence to be recorded from becoming discontinuous.

The optical information device according to one aspect of the present invention is an optical information device which records information by converging a main beam and a sub beam on an information layer of an information recording medium, the device comprising a focus control unit for performing control so that a convergent point of the main beam converges on a predetermined information layer, a tracking control unit for performing control so that the convergent point of the main beam scans a predetermined track or a predetermined mark sequence on an information layer, a sub beam receiving unit for receiving the sub beam reflected off the information layer and outputting a signal according to an amount of beam received, and a loss-of-control detection unit for detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal from the sub beam receiving unit.

According to the foregoing configuration, the focus control unit performs control so that a convergent point of the main beam converges on a predetermined information layer. The tracking control unit performs control so that the convergent point of the main beam scans a predetermined track or a predetermined mark sequence on an information layer. The sub beam receiving unit receives the sub beam reflected off the information layer and outputs a signal according to an amount of beam received. The loss-of-control detection unit detects, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal from the sub beam receiving unit.

According to the present invention, since a focus loss-of-control state or a tracking loss-of-control state is detected, it is possible to prevent previously recorded information from being erroneously destroyed and prevent the mark sequence to be recorded from becoming discontinuous. Consequently, the recording reliability of the optical information device can be improved.

The object, features and advantages of the present invention will become more apparent from the ensuing detailed explanation and appended drawings.

### BRIEF DESCRIPTION OF THE DRAWINGS

FIG. 1 is a block diagram showing the configuration of the optical disc device in Embodiment 1 of the present invention.

FIG. 2 is a schematic diagram showing an example of the configuration of the optical disc in Embodiment 1 of the present invention.

FIG. 3 is a schematic diagram showing an example of the irradiating position of the main beam spot, the preceding sub beam spot and the following sub beam spot formed on the information layer of the optical disc in Embodiment 1 of the present invention.

FIG. 4 is a plan view showing the detection region of the main detector and the sub beam receiving unit in the optical pickup shown in FIG. 1.

FIG. 5 is a block diagram showing the configuration of the FE operation part shown in FIG. 1.

FIG. 6 is a block diagram showing the configuration of the SS operation part shown in FIG. 1.

FIG. 7A is a waveform diagram showing the change in the sub beam synthesized signal when the recording/reproduction optical beam is converged on the information layer containing an unrecorded region due to the focus loss-of-control, and FIG. 7B is a waveform diagram showing the change in the sub beam synthesized signal when the recording/reproduction optical beam is converged on the information layer containing a recorded region due to the focus loss-of-control.

FIG. 8A is a waveform diagram showing the change in the SSa signal or the SSb signal when the recording/reproduction optical beam moves to the unrecorded region due to the loss-of-control, FIG. 8B is a waveform diagram showing the change in the SSa signal or the SSb signal when the recording/reproduction optical beam moves to the recorded region due to the loss-of-control, and FIG. 8C is a waveform diagram showing the change in the modulation degree of the SSa signal or the SSb signal when the recording/reproduction optical beam moves to the unrecorded region or the recorded region due to the loss-of-control.

FIG. 9 is a block diagram showing the configuration of the optical disc device in Embodiment 2 of the present invention.

FIG. 10 is a schematic diagram showing an example of the irradiating position of the main beam spot, the preceding sub beam spot and the following sub beam spot formed on the information layer of the optical disc in Embodiment 2 of the present invention.

FIG. 11 is a block diagram showing the configuration of the dSS operation part shown in FIG. 9.

FIG. 12 is a waveform diagram showing the change in the sub beam difference signal dSS when a loss-of-control occurs during the recording operation in Embodiment 2 of the present invention.

FIG. 13 is a schematic diagram showing an example of the irradiating position of the main beam spot, the preceding sub beam spot and the following sub beam spot formed on the information layer of the optical disc in the first modified example of Embodiment 2.

FIG. 14 is a schematic diagram showing an example of the irradiating position of the main beam spot, the preceding sub beam spot and the following sub beam spot formed on the information layer of the optical disc in the second modified example of Embodiment 2.

FIG. 15 is a diagram showing the configuration of the information recording medium in Embodiment 3 of the present invention.

FIG. 16 is a block diagram showing the configuration of the recording device in Embodiment 3 of the present invention.

FIG. 17 is a schematic diagram showing an example of the arrangement of the scatterer and the resonance element in Embodiment 3.

FIG. 18 is a waveform diagram showing the change in the signal from the resonance state detection unit when the tracking loss-of-control occurs during the recording operation in Embodiment 3 of the present invention.

FIG. 19 is a schematic diagram showing an example of the arrangement of the scatterer and the resonance element in the first modified example of Embodiment 3.

FIG. 20 is a schematic diagram showing an example of the arrangement of the scatterer and the resonance element in the second modified example of Embodiment 3.

FIG. 21 is a schematic diagram showing an example of the arrangement of the scatterer and the resonance element in the third modified example of Embodiment 3.

FIG. 22 is a block diagram showing the configuration of the recording device in Embodiment 4 of the present invention.

FIG. 23 is a schematic diagram showing an example of the arrangement of the scatterer, the first resonance element and the second resonance element in Embodiment 4.

FIG. 24 is a waveform diagram showing the change in the difference in the level of the signal from the first resonance state detection unit and the level of the signal from the second resonance state detection unit when the tracking loss-of-control occurs during the recording operation in Embodiment 4 of the present invention.

FIG. 25 is a schematic diagram showing an example of the arrangement of the scatterer, the first resonance element and the second resonance element in the first modified example of Embodiment 4.

FIG. 26 is a schematic diagram showing an example of the arrangement of the scatterer, the first resonance element and the second resonance element in the second modified example of Embodiment 4.

FIG. 27 is a schematic diagram showing an example of the arrangement of the scatterer, the first resonance element and the second resonance element in the third modified example of Embodiment 4.

### DESCRIPTION OF EMBODIMENTS

Embodiments of the present invention are now explained with reference to the appended drawings. Note that the ensuing embodiments are merely examples that embody the present invention, and are not intended to limit the technical scope of the present invention.

Here, for example, when the number of information layers of an optical disc is to be increased to achieve higher densification, spacing between the mutually adjacent information layers will become narrow pursuant to the increase in the number of layers. Pursuant to the narrowing of the spacing between the mutually adjacent information layers, the stray light component of other layers contained in the reflected light from the information layer will increase. Thus, the detection range of the FE signal that is generated from the reflected light will become narrow. Here, with a conventional optical disc device, it becomes difficult to set a threshold for differentiating the FE signal level based on a control residual error in normal focus control during the recording operation, and the FE signal level upon the occurrence of a focus jump during the recording operation. Consequently, it is not possible to accurately detect the focus jump. In addition, when a focus jump occurs in this kind of optical disc, since the spacing between the mutually adjacent information layers is narrow, there is a possibility that the focus control will be performed to the information layer that is adjacent to the target information layer.

Accordingly, particularly in an optical disc in which the spacing between the mutually adjacent information layers is narrow, when a focus jump occurs during the recording operation and the focus control is erroneously performed to the information layer that is adjacent to the target information layer, it is difficult to detect the focus jump and discontinue the recording operation. Thus, there is a possibility that information, which was previously recorded on another information layer, may be erroneously destroyed.

Moreover, with an optical disc in which the servo layer for controlling the position of the optical beam spot and the information layer for recording information are separated, there are cases where a guide groove does not exist on the information layer. In the foregoing case, since it is not possible to detect the TE signal, there is a possibility that the track jump of the recording optical beam cannot be detected accurately based on the TE signal during the recording operation. Accordingly, even if a track jump occurs during the recording operation, it is not possible to detect that track jump and discontinue the recording operation. Thus, previously recorded information may become erroneously destroyed and the mark sequence to be recorded may become discontinuous.

As examples for resolving the foregoing problems, Embodiments 1 to 4 are described below.

### Embodiment 1

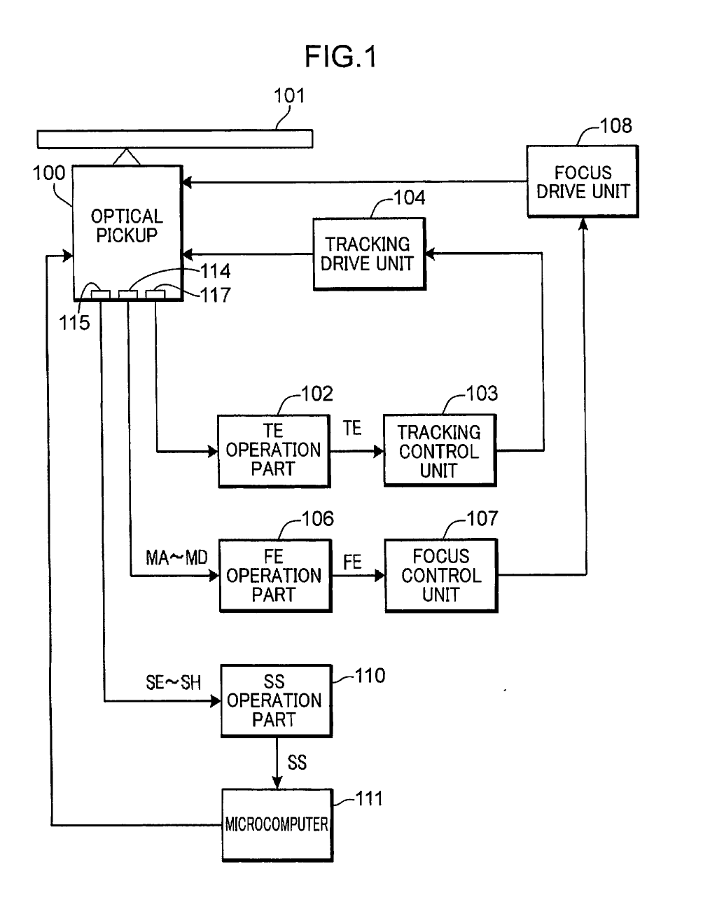

FIG. 1 is a block diagram showing the configuration of the optical disc device in Embodiment 1 of the present invention. The optical disc device records information by converging a main beam and a sub beam on an information layer of an optical disc.

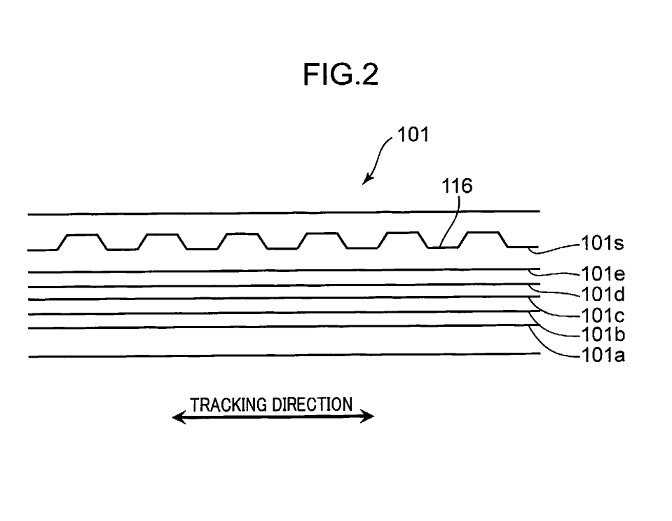

FIG. 2 is a schematic diagram showing an example of the configuration of the optical disc 101 in Embodiment 1 of the present invention. In FIG. 2, the horizontal direction of the plane of paper is the tracking direction. As shown in FIG. 2, the optical disc 101 comprises one servo layer 101s and five information layers 101a to 101e. A track 116 is formed on the servo layer 101s via a guide groove. Meanwhile, no tracks are formed on the information layers 101a to 101e. Moreover, the information layers 101a to 101e respectively include a write-once recording film.

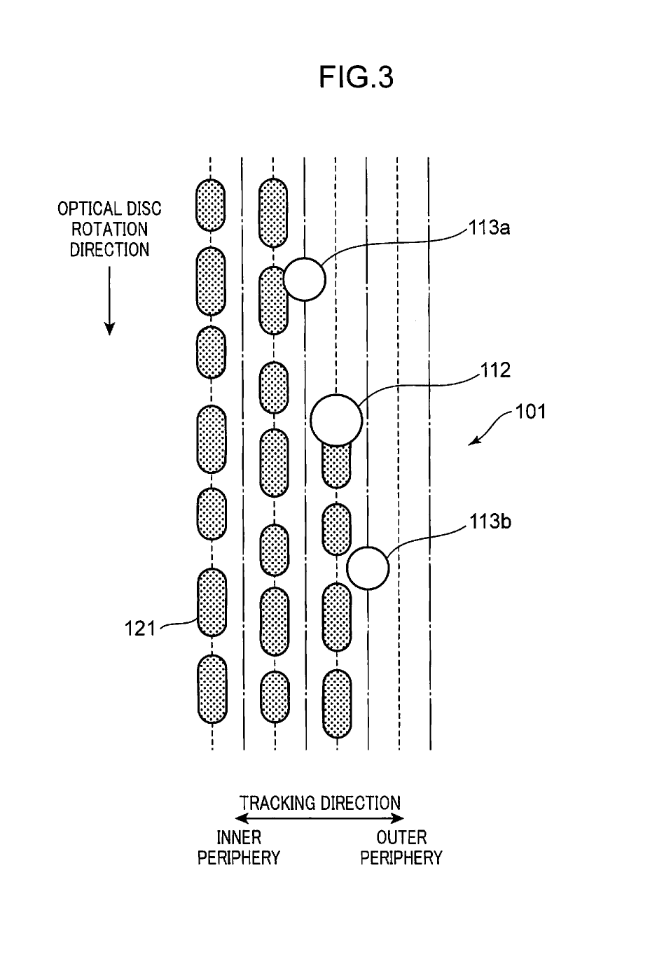

FIG. 3 is a schematic diagram showing an example of the irradiating position of the main beam spot 112, the preceding sub beam spot 113a and the following sub beam spot 113b formed on the information layer of the optical disc 101 in Embodiment 1 of the present invention.

In FIG. 3, the direction from up to down on the plane of paper is the rotating direction of the optical disc 101, the horizontal direction of the plane of paper is the tracking direction, the left direction of the plane of paper is the inner peripheral direction, and the right direction of the plane of paper is the outer peripheral direction. In FIG. 3, the broken line shows the radial position corresponding to the center of the track in the servo layer 101s, and the dashed line shows the radial position between the two adjacent tracks. As shown in FIG. 3, the irradiating position of the preceding sub beam spot 113a is positioned on the inner peripheral side by 0.5 tracks relative to the main beam spot 112. Moreover, the irradiating position of the following sub beam spot 113b is positioned on the outer peripheral side by 0.5 tracks relative to the main beam spot 112.

Note that, in Embodiment 1, while information is recorded from the inner periphery toward the outer periphery of the optical disc 101, the present invention is not particularly limited thereto, and information may also be recorded from the outer periphery toward the inner periphery.

Moreover, when the main beam is converging at the center of the track, the preceding sub beam is converging on the recorded region side where information is recorded. When the main beam is converging at the center of the track, the following sub beam is converging on the unrecorded region side where information is not recorded.

The optical disc device shown in FIG. 1 comprises an optical pickup 100, a TE operation part 102, a tracking control unit 103, a tracking drive unit 104, an FE operation part 106, a focus control unit 107, a focus drive unit 108, an SS operation part 110 and a microcomputer 111.

At least one servo layer is irradiated with the servo optical beam that was condensed by the optical pickup 100, and a plurality of information layers are irradiated with the recording/reproduction optical beam that was condensed by the optical pickup 100.

The optical pickup 100 comprises a recording/reproduction light source for emitting a recording/reproduction optical beam, a servo light source for emitting a servo optical beam, a first collimator lens for converting the recording/reproduction optical beam emitted from the recording/reproduction light source substantially into parallel light, a second collimator lens for converting the servo optical beam emitted from the servo light source substantially into parallel light, a diffraction element for separating the recording/reproduction optical beam into a main beam and a sub beam, an objective lens for condensing the recording/reproduction optical beam on one among a plurality of information layers and condensing the servo optical beam on at least one servo layer, a beam splitter for causing the optical axis of the recording/reproduction optical beam that was converted substantially into parallel light by the first collimator lens and the optical axis of the servo optical beam that was converted substantially into parallel light by the second collimator lens to coincide, and guiding the recording/reproduction optical beam and the servo optical beam to the objective lens, an objective lens actuator for moving the objective lens in the optical axis direction, moving the focal point of the recording/reproduction optical beam to the information layer, moving the objective lens in a radial direction of the optical disc 101, and causing the convergent point of the main beam to follow a predetermined track or a predetermined mark sequence on the information layer, and a collimator lens actuator for moving the second collimator lens in the optical axis direction and moving the focal point of the servo optical beam to the servo layer.

Moreover, the optical pickup 100 additionally comprises a main detector 114, a sub beam receiving unit 115 and a servo optical beam receiving unit 117.

The main detector 114 receives the main beam reflected off the information layer, and outputs a signal according to the amount of beam received. The sub beam receiving unit 115 receives the sub beam reflected off the information layer, and outputs a signal according to the amount of beam received. In Embodiment 1, the sub beam receiving unit 115 receives two sub beams reflected off the information layer, and outputs two signals according to the respective amounts of the beams received. The servo optical beam receiving unit 117 receives the servo optical beam reflected off the servo layer, and outputs a signal according to the amount of beam received.

Note that, as the optical pickup 100, for example, the recording/reproduction device described in Japanese Patent Application Publication No. 2005-317180 may be used.

The TE operation part 102 computes, based on the signal output from the servo optical beam receiving unit 117, a tracking error signal TE indicating a position gap between the beam spot of the servo optical beam and the center of the track of the servo layer 101s in the tracking direction.

The tracking control unit 103 performs control, based on the tracking error signal TE computed by the TE operation part 102, so that the convergent point of the main beam scans a predetermined track or a predetermined mark sequence on the information layer. The tracking control unit 103 performs predetermined signal processing to the tracking error signal TE computed by the TE operation part 102 and generates a tracking drive signal, and outputs the generated tracking drive signal to the tracking drive unit 104.

The tracking drive unit 104 drives the objective lens actuator of the optical pickup 100 based on the tracking drive signal generated by the tracking control unit 103. The objective lens actuator simultaneously moves the beam spot of the servo optical beam, the main beam spot of the recording/reproduction optical beam, and the two sub beam spots of the recording/reproduction optical beam in the tracking direction.

The FE operation part 106 computes, based on the signal output from the main detector 114, a focus error signal FE indicating a position gap between the main beam spot and the information layer in the focus direction.

The focus control unit 107 performs control, based on the focus error signal FE computed by the FE operation part 106, so that the convergent point of the main beam converges on a predetermined information layer. The focus control unit 107 performs predetermined signal processing to the focus error signal FE computed by the FE operation part 106 and generates a focus drive signal, and outputs the generated focus drive signal to the focus drive unit 108.

The focus drive unit 108 drives the objective lens actuator of the optical pickup 100 based on the focus drive signal generated by the focus control unit 107. The objective lens actuator moves the main beam spot of the recording/reproduction optical beam and the two sub beam spots of the recording/reproduction optical beam in the focus direction.

The SS operation part 110 computes a sub beam synthesized signal SS by synthesizing the two signals output from the sub beam receiving unit 115.

The microcomputer 111 detects, during the recording operation of recording information, a focus loss-of-control state where the convergent point of the main beam deviates from a predetermined information layer or a tracking loss-of-control state where the convergent point of the main beam deviates from a predetermined track or a predetermined mark sequence on the information layer, based on a signal from the sub beam receiving unit 115. The microcomputer 111 detects, during the recording operation of the optical disc device, whether the recording/reproduction optical beam is in a loss-of-control state based on the sub beam synthesized signal SS computed by the SS operation part 110.

The microcomputer 111 detects the focus loss-of-control state or the tracking loss-of-control state when a level of the signal output from the sub beam receiving unit 115 is a reflected light level from a recorded region where information is recorded or a reflected light level from an unrecorded region where information is not recorded.

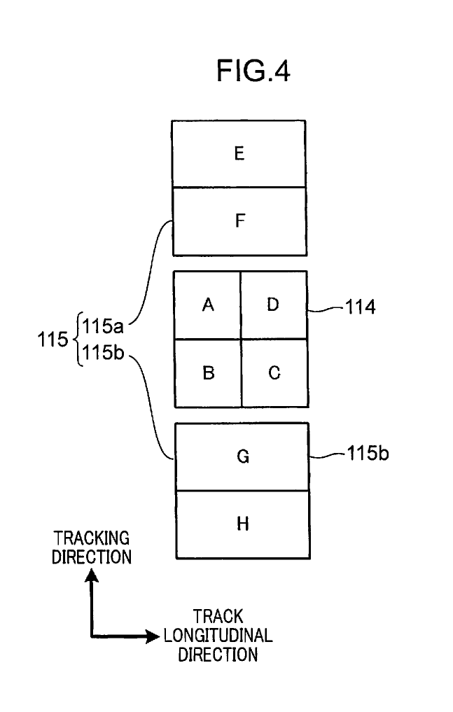

FIG. 4 is a plan view showing the detection region of the main detector 114 and the sub beam receiving unit 115 in the optical pickup 100 shown in FIG. 1. In FIG. 4, the vertical direction of the plane of paper is the tracking direction of the optical disc 101, and the horizontal direction of the plane of paper is the longitudinal direction of the track.

As shown in FIG. 4, the main detector 114 is split into four light-receiving regions A to D. Moreover, the sub beam receiving unit 115 comprises a first sub detector 115a and a second sub detector 115b. The first sub detector 115a receives the reflected light of the preceding sub beam of the two sub beams. The second sub detector 115b receives the reflected light of the following sub beam of the two sub beams. The first sub detector 115a is split into two light-receiving regions E, F. Similarly, the second sub detector 115b is split into two light-receiving regions G, H in the tracking direction.

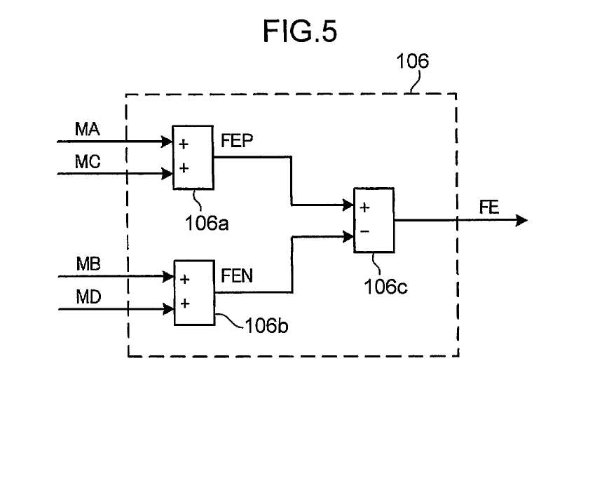

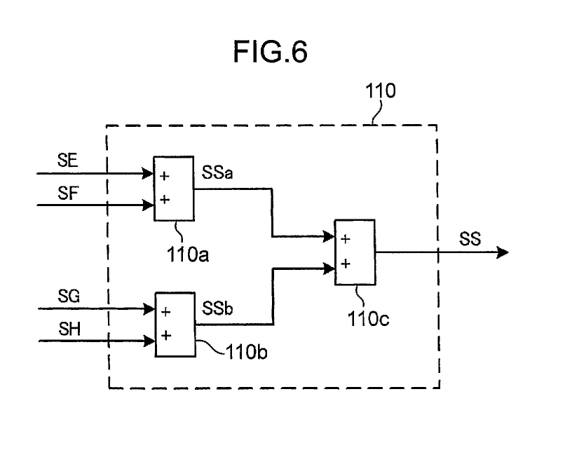

FIG. 5 is a block diagram showing the configuration of the FE operation part 106 shown in FIG. 1. FIG. 6 is a block diagram showing the configuration of the SS operation part 110 shown in FIG. 1.

The FE operation part 106 comprises an adder 106a, an adder 106b, and a subtractor 106c.

The SS operation part 110 comprises an adder 110a, an adder 110b, and an adder 110c.

Note that, in Embodiment 1, the optical disc device corresponds to an example of the optical information device, the focus control unit 107 and the focus drive unit 108 correspond to an example of the focus control unit, the tracking control unit 103 and the tracking drive unit 104 correspond to an example of the tracking control unit, the sub beam receiving unit 115 corresponds to an example of the sub beam receiving unit, and the SS operation part 110 and the microcomputer 111 correspond to an example of the loss-of-control detection unit.

The operation of the optical disc device configured as described above is now explained.

The optical disc 101 is irradiated with the servo optical beam and the recording/reproduction optical beam by the optical pickup 100. The recording/reproduction optical beam emitted from the recording/reproduction light source is split, by an optical element such as a diffraction grating in the optical pickup 100, into one main beam as 0th-order diffracted light and two sub beams as ±first-order light. The recording/reproduction optical beam configured from one main beam and two sub beams is converged, for example, on the first information layer 101a.

As shown in FIG. 3, the one main beam forms one main beam spot 112 on the first information layer 101a, and the two sub beams form a preceding sub beam spot 113a and a following sub beam spot 113b on the first information layer 101a. The main beam that converged on the first information layer 101a is reflected by the first information layer 101a and then enters the optical pickup 100. The main beam that entered the optical pickup 100 subsequently enters the main detector 114.

The main beam that entered the main detector 114 is converted into electrical signals MA to MD at the respective light-receiving regions A to D in the main detector 114, and subsequently output. The electrical signals MA to MD from the main detector 114 are input to the FE operation part 106. The adder 106a adds the electrical signals MA, MC, and outputs the result as an FEP signal to the subtractor 106c. The adder 106b adds the electrical signals MB, MD, and outputs the result as an FEN signal to the subtractor 106c. The FEP signal and the FEN signal are input to the subtractor 106c.

The subtractor 106c subtracts the FEN signal from the FEP signal, and outputs the result as the focus error signal FE indicating the position gap between the main beam spot and the information layer A in the focus direction. The focus error signal FE is input to the focus control unit 107. The focus control unit 107 generates a focus drive signal by causing the focus error signal FE to pass through a phase compensation circuit and a low frequency compensation circuit configured from a digital filter of a digital signal processor (hereinafter referred to as the “DSP”) or the like. The focus drive signal is input to the focus drive unit 108.

The focus drive unit 108 amplifies the focus drive signal, and outputs the amplified focus drive signal to the optical pickup 100. The objective lens actuator of the optical pickup 100 moves the objective lens in the focus direction and moves the main beam spot and the two sub beam spots of the recording/reproduction optical beam in the focus direction based on the amplified focus drive signal.

According to the operation described above, focus control of performing control so that the main beam spot of the recording/reproduction optical beam is correctly converged on the first information layer 101a of the optical disc 101 is realized by the focus error signal FE and the focus control unit 107.

Meanwhile, the servo optical beam emitted from the servo light source is converged on the servo layer 101s. The beam spot of the servo optical beam is controlled by a servo focus control unit (not shown) so as to correctly converge on the servo layer 101s of the optical disc 101. For example, the servo focus control unit moves the second collimator lens, which converts the servo optical beam emitted from the servo light source substantially into parallel light, in the optical axis direction, and moves the focal point of the servo optical beam to the servo layer 101s.

The reflected light of the servo optical beam converged on the servo layer 101s is received by the servo optical beam receiving unit 117, and converted into an electrical signal and output. The output signal from the servo optical beam receiving unit 117 is input to the TE operation part 102. The TE operation part 102 computes the input signal, and outputs the result as the tracking error signal TE indicating the position gap between the beam spot of the servo optical beam and the center of the track of the servo layer 101s. The tracking error signal TE is input to the tracking control unit 103.

The tracking control unit 103 generates a tracking drive signal by causing the tracking error signal TE to pass through a phase compensation circuit and a low frequency compensation circuit configured from a digital filter such as a DSP. The tracking drive signal is input to the tracking drive unit 104. The tracking drive unit 104 amplifies the tracking drive signal and outputs the amplified tracking drive signal to the optical pickup 100. The objective lens actuator of the optical pickup 100 moves the objective lens in the tracking direction, and simultaneously moves the beam spot of the servo optical beam, the main beam spot of the recording/reproduction optical beam, and the two sub beam spots of the recording/reproduction optical beam in the tracking direction based on the amplified tracking drive signal.

According to the operation described above, tracking control of performing control so that the servo optical beam is correctly converged at the center of the track on the servo layer 101s of the optical disc 101 and so that the recording/reproduction optical beam is correctly converged at a radial position corresponding to the center of the track on the servo layer 101s on the first information layer 101a without any tracks is realized by the tracking error signal TE and the tracking control unit 103.

In addition, the two sub beams that converged on the first information layer 101a are reflected by the first information layer 101a, and enter the optical pickup 100. The two sub beams that entered the optical pickup 100 respectively enter the first sub detector 115a and the second sub detector 115b. The sub beam that entered the first sub detector 115a is converted into electrical signals SE, SF at the respective light-receiving regions E, F in the first sub detector 115a, and subsequently output. The sub beam that entered the second sub detector 115b is converted into electrical signals SG, SH at the respective light-receiving regions G, H in the second sub detector 115b, and subsequently output.

The electrical signals SE, SF from the first sub detector 115a are input to the SS operation part 110. The adder 110a adds the electrical signals SE, SF, and outputs the result as an SSa signal to the adder 110c. The electrical signals SG, SH from the second sub detector 115b are input to the SS operation part 110. The adder 110b adds the electrical signals SG, SH, and outputs the result as an SSb signal to the adder 110c. The SSa signal and the SSb signal are input to the adder 110c.

The adder 110c adds the SSa signal and the SSb signal, and outputs the result as a sub beam synthesized signal SS. The sub beam synthesized signal SS is input to the microcomputer 111. The microcomputer 111 detects, during the recording operation of the optical disc device, whether the recording/reproduction optical beam is in a loss-of-control state based on the signal level of the input sub beam synthesized signal SS.

In other words, the microcomputer 111 detects the focus loss-of-control state or the tracking loss-of-control state when the sum of the level of the signal output from the first sub detector 115a and the level of the signal output from the second sub detector 115b is the reflected light level from a recorded region where information is recorded or the reflected light level from an unrecorded region where information is not recorded.

When a loss-of-control state is detected, the microcomputer 111 outputs a control signal to the optical pickup 100 to discontinue to the recording operation. The optical pickup 100 discontinues the recording operation based on the control signal from the microcomputer 111. The recording operation of the optical disc device is thereby discontinued.

According to the operation described above, when a focus loss-of-control state or a tracking loss-of-control state occurs during the recording operation, the optical disc device can detect the focus loss-of-control state or the tracking loss-of-control state with the microcomputer (loss-of-control detection unit) 111 and discontinue the recording operation.

The loss-of-control detection method during the recording operation using the sub beam synthesized signal SS in Embodiment 1 is now explained.

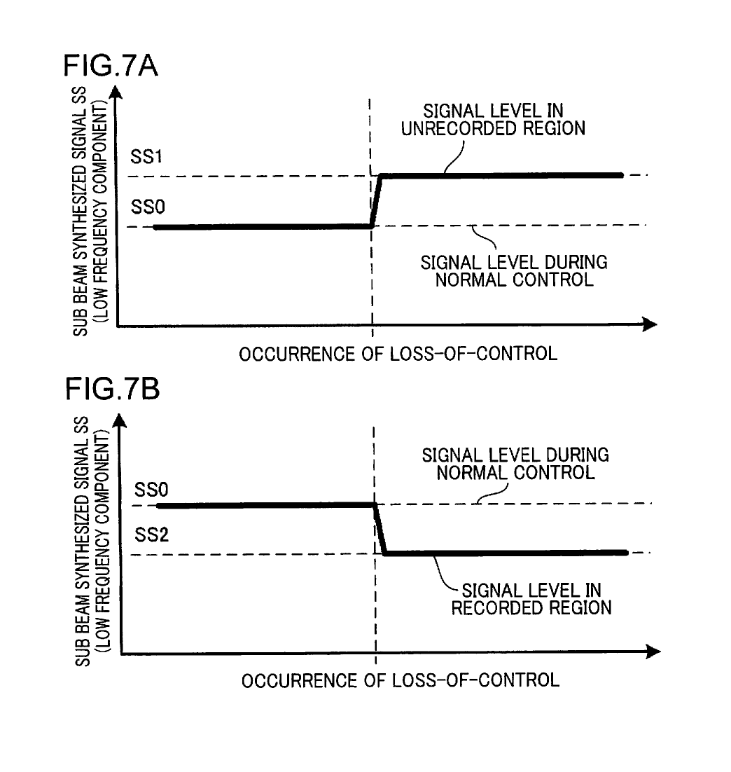

FIG. 7A and FIG. 7B are waveform diagrams showing the change in the sub beam synthesized signal SS when a focus loss-of-control, which is one type of loss-of-control, occurs during the recording operation, and the recording/reproduction optical beam converges on an information layer that is different from the target information layer. Here, FIG. 7A is a waveform diagram showing the change in the sub beam synthesized signal SS when the recording/reproduction optical beam is converged on the information layer containing an unrecorded region due to the focus loss-of-control. Moreover, FIG. 7B is a waveform diagram showing the change in the sub beam synthesized signal SS when the recording/reproduction optical beam is converged on the information layer containing a recorded region due to the focus loss-of-control. Here, let it be assumed that the optical disc 101 is a High-to-Low disc (hereinafter referred to as the “HTL disc”) in which the reflectance decreases when information is recorded thereon.

During a normal recording operation to the optical disc 101 having a write-once information layer, the recording/reproduction optical beam is constantly positioned at the recording boundary, which is the boundary of the recorded region and the unrecorded region. Here, as shown in FIG. 3, at the irradiating position of the preceding sub beam spot 113a and the following sub beam spot 113b, a mark sequence (recorded region) constantly exists on the inner peripheral side, and an unrecorded region exists on the outer peripheral side. Accordingly, the sub beam synthesized signal SS as the sum of the amount of reflected light from the preceding sub beam spot 113a and the following sub beam spot 113b will become a certain signal level SS0 as shown in FIG. 7A.

Meanwhile, when, for example, focus loss-of-control occurs during the recording operation, and the recording/reproduction optical beam converges on an information layer that is different from the target information layer, the recording/reproduction optical beam will deviate from the recording boundary. Thus, the irradiating position of the preceding sub beam spot 113a and the following sub beam spot 113b in a different information layer will not satisfy the foregoing relationship.

In other words, if the region of the destination where the recording/reproduction optical beam converged is an unrecorded region, the irradiating positions of the preceding sub beam spot 113a and the following sub beam spot 113b will both be in an unrecorded region. Thus, the signal level of the sub beam synthesized signal SS as the sum of the amount of reflected light from the preceding sub beam spot 113a and the following sub beam spot 113b will increase, as shown in FIG. 7A, from the signal level SS0 to a signal level SS1.

Moreover, if the region of the destination where the recording/reproduction optical beam converged is a recorded region, the irradiating positions of the preceding sub beam spot 113a and the following sub beam spot 113b will both be in the recorded region. Thus, the signal level of the sub beam synthesized signal SS will decrease, as shown in FIG. 7B, from the signal level SS0 to a signal level SS2.

Accordingly, the signal level of the sub beam synthesized signal SS as the sum of the amount of reflected light from the preceding sub beam spot 113a and the following sub beam spot 113b will change due to the focus loss-of-control that occurs during the recording operation.

In Embodiment 1, the focus loss-of-control during the recording operation is detected based on the change in the signal level of the sub beam synthesized signal SS described above. In other words, the microcomputer 111 detects, during the recording operation, that the signal level of the sub beam synthesized signal SS changed from the signal level SS0 in a normal operation to the signal level SS1 or the signal level SS2. It is thereby possible to detect the focus loss-of-control.

Moreover, also in a case where the tracking loss-of-control, which is one type of loss-of-control, occurs, the signal level of the sub beam synthesized signal SS will change according to the condition of the region of the destination to where the recording/reproduction optical beam had moved. Thus, similar to the case of focus loss-of-control, the microcomputer 111 detects, during the recording operation, that the signal level of the sub beam synthesized signal SS changed from the signal level SS0 in a normal operation to the signal level SS1 or the signal level SS2. It is thereby possible to detect the tracking loss-of-control.

Accordingly, in Embodiment 1, the optical disc device can accurately detect the focus loss-of-control or the tracking loss-of-control during the recording operation by using the sub beam synthesized signal SS, and discontinue the recording operation. Thus, it is possible to prevent previously recorded information from being erroneously destroyed and prevent the mark sequence to be recorded from becoming discontinuous. Consequently, the recording reliability of the optical information device can be improved.

Note that the optical disc device may also comprise a memory for pre-storing a signal level SS1 indicating a reflected light level from an unrecorded region where information is not recorded, and a signal level SS2 indicating a reflected light level from a recorded region where information is recorded. The microcomputer 111 may read the signal level SS1 and the signal level SS2 from the memory, and compare the read signal level SS1 and signal level SS2 with the level of the signal from the sub beam receiving unit 115. In the foregoing case, the microcomputer 111 detects the focus loss-of-control state or the tracking loss-of-control state when the level of the signal from the sub beam receiving unit 115 is the signal level SS1 or the signal level SS2.

As described above, the optical disc device of Embodiment 1 is mainly configured as described below.

In other words, the optical disc device of Embodiment 1 is an optical disc device which records information by converging a main beam and a sub beam on an information layer of an information recording medium, the optical disc device comprising a focus control unit for performing control so that a convergent point of the main beam converges on a predetermined information layer, a tracking control unit for performing control so that the convergent point of the main beam scans a predetermined track or a predetermined mark sequence on an information layer, a sub beam receiving unit for receiving the sub beam reflected off the information layer and outputting a signal according to an amount of beam received, and a loss-of-control detection unit for detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal from the sub beam receiving unit.

According to the foregoing configuration, it is possible to prevent previously recorded information from being erroneously destroyed and prevent the mark sequence to be recorded from becoming discontinuous. Consequently, the recording reliability of the optical information device can be improved.

In addition, with the optical disc device of Embodiment 1, the loss-of-control detection unit may detect the focus loss-of-control state or the tracking loss-of-control state when a level of the signal output from the sub beam receiving unit is a reflected light level from a recorded region where information is recorded or a reflected light level from an unrecorded region where information is not recorded.

Note that, in Embodiment 1, while the sub beam synthesized signal SS used for the detection of the loss-of-control during the recording operation is a result of adding the SSa signal and the SSb signal; that is, the sum signal of the amount of reflected light of the preceding sub beam spot 113a and the amount of reflected light of the following sub beam spot 113b, similar effects can be obtained even when only one of either the SSa signal or the SSb signal is used for the detection of the loss-of-control.

Note that, in Embodiment 1, while the configuration detects the loss-of-control during the recording operation based on the change in the signal level of the sub beam synthesized signal SS, the following configuration may also be adopted. In other words, only one of either the SSa signal or the SSb signal is input to the microcomputer 111, and the microcomputer 111 may detect the loss-of-control during the recording operation based on the change in the modulation degree of the input signal.

Moreover, in Embodiment 1, while two sub beams are converged on the optical disc 101, the present invention is not particularly limited thereto, and only one sub beam may be converged on the optical disc 101. The optical disc device may form, for example, only one of either the preceding sub beam spot 113a or the following sub beam spot 113b shown in FIG. 3 on the optical disc 101.

In other words, when the optical beam is split into a main beam and one sub beam, and the one sub beam converges on a recorded region side where information is recorded when the main beam is converged at the center of the track, the microcomputer 111 detects the focus loss-of-control state or the tracking loss-of-control state when the level of the signal from the sub beam receiving unit 115 changes from a reflected light level from the recorded region to a reflected light level from the unrecorded region.

Moreover, when the optical beam is split into a main beam and one sub beam, and the one sub beam converges on an unrecorded region side where information is not recorded when the main beam is converged at the center of the track, the microcomputer 111 detects the focus loss-of-control state or the tracking loss-of-control state when the level of the signal from the sub beam receiving unit 115 changes from a reflected light level from the unrecorded region to a reflected light level from the recorded region.

In addition, when the optical beam is split into a main beam and one sub beam, and the one sub beam converges on a boundary of an unrecorded region side where information is not recorded and a recorded region where information is recorded when the main beam is converged at the center of the track, the microcomputer 111 may detect the focus loss-of-control state or the tracking loss-of-control state when the level of the signal from the sub beam receiving unit 115 is a reflected light level from the unrecorded region or a reflected light level from the recorded region.

Furthermore, in Embodiment 1, three or more sub beams may also be converged on the optical disc 101.

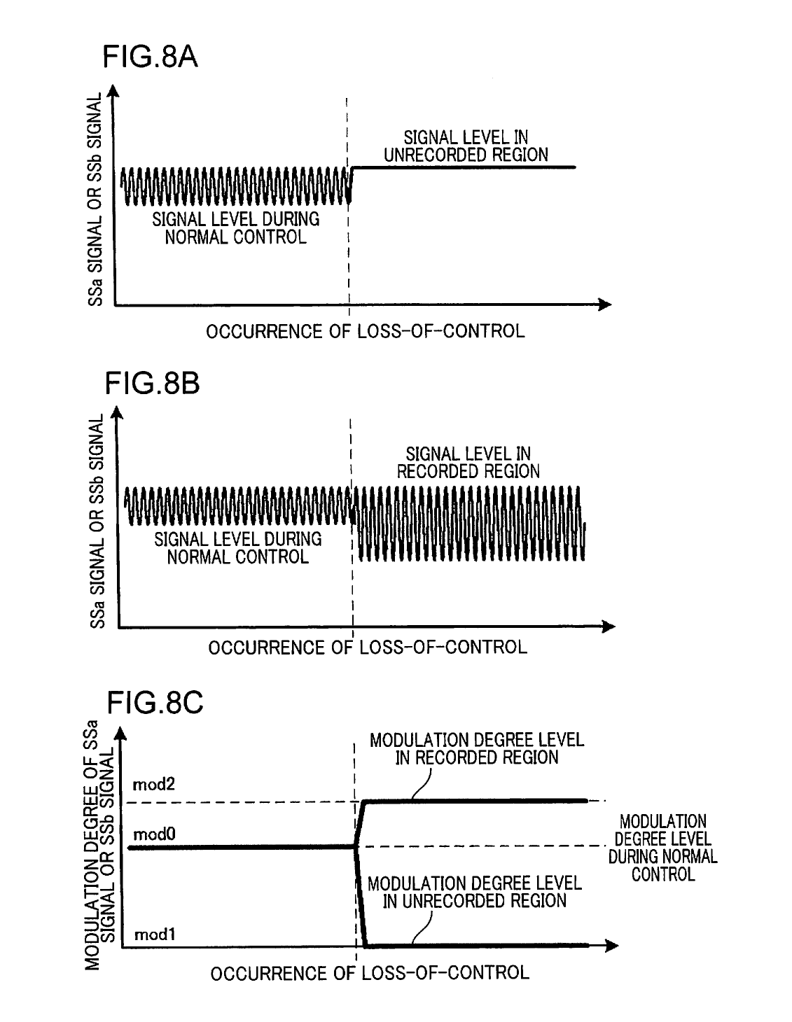

Here, the detection of loss-of-control during the recording operation in a modified example of Embodiment 1 is now explained with reference to FIG. 8A, FIG. 8B and FIG. 8C. FIG. 8A is a waveform diagram showing the change in the SSa signal or the SSb signal when the recording/reproduction optical beam moves to the unrecorded region due to the loss-of-control. FIG. 8B is a waveform diagram showing the change in the SSa signal or the SSb signal when the recording/reproduction optical beam moves to the recorded region due to the loss-of-control. FIG. 8C is a waveform diagram showing the change in the modulation degree of the SSa signal or the SSb signal when the recording/reproduction optical beam moves to the unrecorded region or the recorded region due to the loss-of-control.

As described above, during a normal recording operation, at the irradiating position of the preceding sub beam spot 113a and the following sub beam spot 113b, a mark sequence constantly exists on the inner peripheral side, and an unrecorded region exists on the outer peripheral side. Accordingly, a high-frequency component based on the mark sequence on the inner peripheral side is included in the SSa signal or the SSb signal generated from the reflected light. Thus, the modulation degree in a case where information is recorded normally will be, as shown in FIG. 8C, a certain modulation degree mod0.

Meanwhile, when loss-of-control occurs during the recording operation, the recording/reproduction optical beam will deviate from the recording boundary. Thus, the irradiating position of the preceding sub beam spot 113a and the following sub beam spot 113b will not satisfy the foregoing relationship. In other words, if the region of the destination to where the recording/reproduction optical beam had moved is an unrecorded region, the irradiating positions of the preceding sub beam spot 113a and the following sub beam spot 113b will both be in the same unrecorded region. In the foregoing case, since a mark sequence does not exist in the unrecorded region, a high-frequency component is not included in the SSa signal or the SSb signal, and the modulation degree of the SSa signal or the SSb signal will decrease, as shown in FIG. 8C, from the modulation degree mod0 to a modulation degree mod1.

Moreover, if the region of the destination to where the recording/reproduction optical beam had moved is a recorded region, at the irradiating position of the preceding sub beam spot 113a and the following sub beam spot 113b, a mark sequence will constantly exist on the inner peripheral side and the outer peripheral side. In the foregoing case, a high-frequency component will exist in the SSa signal or the SSb signal, and the modulation degree of the SSa signal or the SSb signal will increase, as shown in FIG. 8C, from the modulation degree mod0 to a modulation degree mod2.

Accordingly, the modulation degree of the SSa signal based on the reflected light from the preceding sub beam spot 113a or the modulation degree of the SSb signal generated based on the reflected light from the following sub beam spot 113b will change due to the loss-of-control that occurs during the recording operation.

In a modified example of Embodiment 1, the focus loss-of-control or the tracking loss-of-control during the recording operation is detected based on the change in the modulation degree of the SSa signal or the SSb signal. The microcomputer 111 detects the focus loss-of-control state or the tracking loss-of-control state when the modulation degree of the signal from the sub beam receiving unit 115 is a modulation degree in the recorded region or a modulation degree in the unrecorded region. In other words, the microcomputer 111 detects, during the recording operation, that the modulation degree of the SSa signal or the SSb signal changed from the modulation degree mod0 in a normal operation to the modulation degree mod1 that is lower than the modulation degree mod0 or to the modulation degree mod2 that is higher than the modulation degree mod0. It is thereby possible to detect the focus loss-of-control or the tracking loss-of-control.

The microcomputer 111 detects the focus loss-of-control state or the tracking loss-of-control state when the sum of the modulation degree of the signal output from the first sub detector 115a and the modulation degree of the signal output from the second sub detector 115b is a modulation degree in the recorded region where information is recorded or a modulation degree in the unrecorded region where information is not recorded.

As described above, with the optical disc device of a modified example of Embodiment 1, the loss-of-control detection unit may detect the focus loss-of-control state or the tracking loss-of-control state when the modulation degree of the signal from the sub beam receiving unit is a modulation degree in the recorded region or a modulation degree in the unrecorded region.

Note that the optical disc device may also comprise a memory for pre-storing the modulation degree mod1 in the unrecorded region where information is not recorded and the modulation degree mod2 in the recorded region where information is recorded. The microcomputer 111 may read the modulation degree mod1 and the modulation degree mod2 from the memory, and compare the read modulation degree mod1 and modulation degree mod2 with the modulation degree of the signal from the sub beam receiving unit 115. In the foregoing case, the microcomputer 111 detects the focus loss-of-control state or the tracking loss-of-control state when the modulation degree of the signal from the sub beam receiving unit 115 is the modulation degree mod1 or the modulation degree mod2.

Note that, in Embodiment 1, while the optical disc 101 is configured by comprising one servo layer and a plurality of information layers, the present invention is not limited to this layer structure of the optical disc 101 in the detection of the loss-of-control during the recording operation. For example, the optical disc 101 may also comprise a plurality of servo layers. Moreover, the optical disc 101 may also comprise one information layer.

Note that, in Embodiment 1, while the optical disc 101 is an HTL disc, there is no particular limitation in the characteristics of the optical disc 101 in the detection of the loss-of-control during the recording operation. In other words, the optical disc 101 may also be a Low-to-High disc (hereinafter referred to as the “LTH disc”) in which the reflectance increases when information is recorded thereon.

In the foregoing case, in the detection of the loss-of-control based on the sub beam synthesized signal SS, when the recording/reproduction optical beam moves to an unrecorded region due to the loss-of-control during the recording operation, the signal level of the sub beam synthesized signal SS will decrease to a signal level of the unrecorded region. Meanwhile, when the recording/reproduction optical beam moves to a recorded region due to the loss-of-control during the recording operation, the signal level of the sub beam synthesized signal SS will increase to a signal level of the recorded region. Accordingly, even if the optical disc 101 is an LTH disc, the loss-of-control can be detected by using the sub beam synthesized signal SS during the recording operation.

Moreover, in the modified example of Embodiment 1, while two sub beams are converged on the optical disc 101, the present invention is not particularly limited thereto, and one sub beam may be converged on the optical disc 101. The optical disc device may form, for example, only one of either the preceding sub beam spot 113a or the following sub beam spot 113b shown in FIG. 3 on the optical disc 101.

In other words, when the optical beam is split into a main beam and one sub beam, and the one sub beam converges on a recorded region side where information is recorded when the main beam is converged at the center of the track, the microcomputer 111 detects the focus loss-of-control state or the tracking loss-of-control state when the modulation degree of the signal from the sub beam receiving unit 115 changes from a modulation degree in the recorded region to a modulation degree in the unrecorded region.

Moreover, when the optical beam is split into a main beam and one sub beam, and the one sub beam converges on an unrecorded region side where information is not recorded when the main beam is converged at the center of the track, the microcomputer 111 detects the focus loss-of-control state or the tracking loss-of-control state when the modulation degree of the signal from the sub beam receiving unit 115 changes from a modulation degree in the unrecorded region to a modulation degree in the recorded region.

In addition, when the optical beam is split into a main beam and one sub beam, and the one sub beam converges on a boundary of an unrecorded region side where information is not recorded and a recorded region where information is recorded when the main beam is converged at the center of the track, the microcomputer 111 may detect the focus loss-of-control state or the tracking loss-of-control state when modulation degree of the signal from the sub beam receiving unit 115 is a modulation degree in the unrecorded region or a modulation degree in the recorded region.

Furthermore, in the modified example of Embodiment 1, three or more sub beams may also be converged on the optical disc 101.

### Embodiment 2

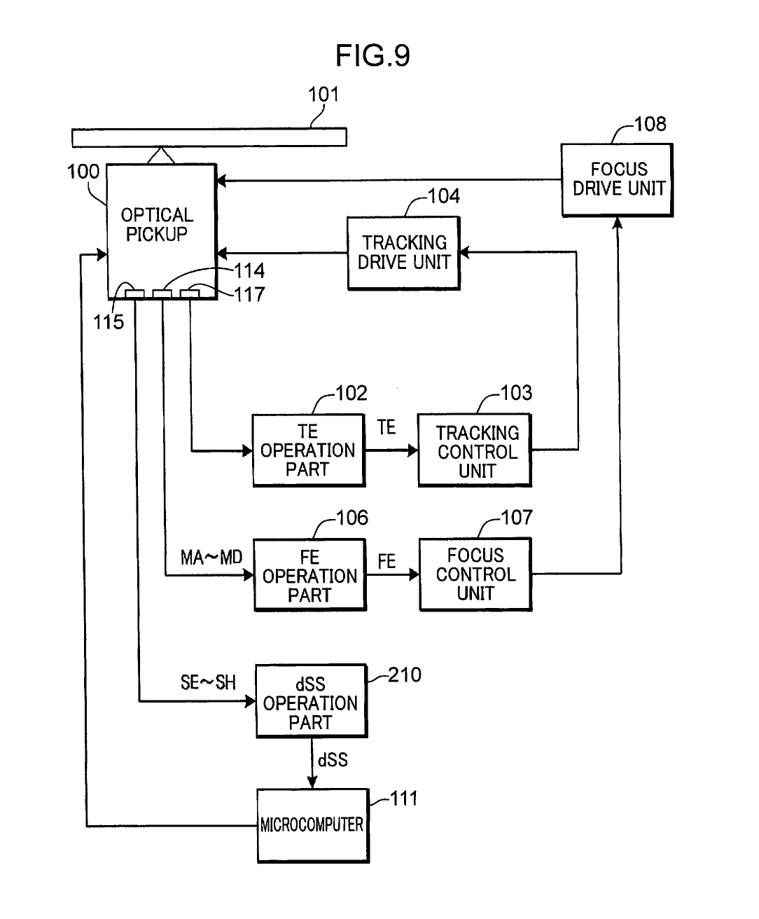

FIG. 9 is a block diagram showing the configuration of the optical disc device in Embodiment 2 of the present invention. Note that the same number as Embodiment 1 is given to the same configuration as Embodiment 1, and the explanation thereof is omitted.

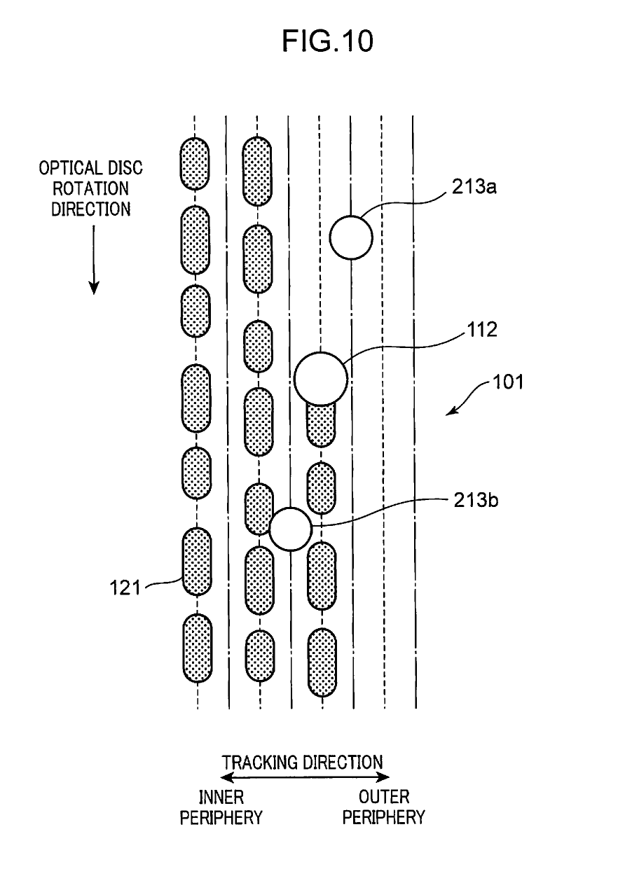

FIG. 10 is a schematic diagram showing an example of the irradiating position of the main beam spot 112, the preceding sub beam spot 213a and the following sub beam spot 213b formed on the information layer of the optical disc 101 in Embodiment 2 of the present invention.

As shown in FIG. 10, the irradiating position of the preceding sub beam spot 213a is positioned on the outer peripheral side by 0.5 tracks relative to the main beam spot 112. Moreover, the irradiating position of the following sub beam spot 213b is positioned on the inner peripheral side by 0.5 tracks relative to the main beam spot 112.

Moreover, when the main beam is converging at the center of the track, the preceding sub beam is converging on the unrecorded region side where information is not recorded. When the main beam is converging at the center of the track, the following sub beam is converging on the recorded region side where information is recorded.

The optical disc device shown in FIG. 9 comprises an optical pickup 100, a TE operation part 102, a tracking control unit 103, a tracking drive unit 104, an FE operation part 106, a focus control unit 107, a focus drive unit 108, a dSS operation part 210 and a microcomputer 111.

The dSS operation part 210 computes a sub beam difference signal dSS by calculating the difference between the two signals output from the sub beam receiving unit 115.

The microcomputer 111 detects, during the recording operation of recording information, a focus loss-of-control state where the convergent point of the main beam deviates from a predetermined information layer or a tracking loss-of-control state where the convergent point of the main beam deviates from a predetermined track or a predetermined mark sequence on the information layer, based on a signal from the sub beam receiving unit 115. The microcomputer 111 detects, during the recording operation of the optical disc device, whether the recording/reproduction optical beam is in a loss-of-control state based on the sub beam difference signal dSS computed by the dSS operation part 210.

The sub beam receiving unit 115 includes a first sub detector 115a (refer to FIG. 4) for receiving a first sub beam reflected off the information layer, and a second sub detector 115b (refer to FIG. 4) for receiving a second sub beam, which is different from the first sub beam, reflected off the information layer.

The microcomputer 111 detects the focus loss-of-control state or the tracking loss-of-control state when the difference in the level of the signal output from the first sub detector 115a and the level of the signal output from the second sub detector 115b is less than a predetermined level.

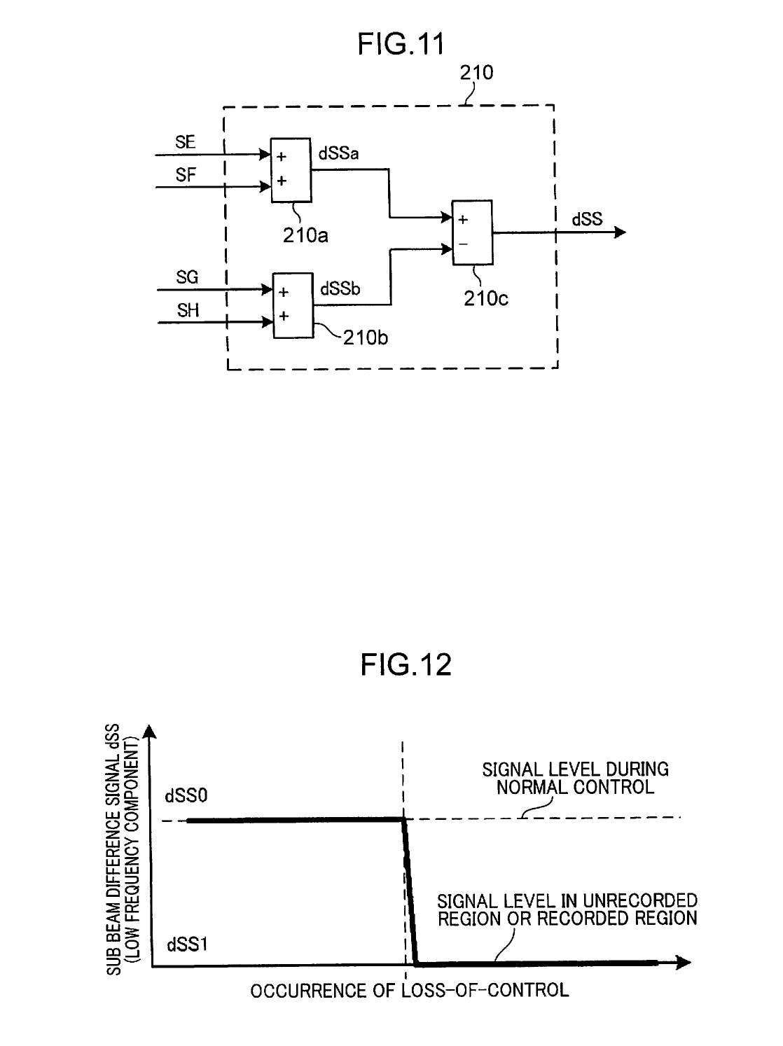

FIG. 11 is a block diagram showing the configuration of the dSS operation part 210 shown in FIG. 9.

The dSS operation part 210 includes an adder 210a, an adder 210b, and a subtractor 210c.

Note that, in Embodiment 2, the first sub detector 115a and the second sub detector 115b correspond to an example of the plurality of sub beam receiving units, and the dSS operation part 210 and the microcomputer 111 correspond to an example of the loss-of-control detection unit.

The operation of the optical disc device configured as described above is now explained. Note that, in the ensuing explanation, explanation regarding the same operation as Embodiment 1 is omitted.

The electrical signals SE, SF from the first sub detector 115a are input to the dSS operation part 210. The adder 210a adds the electrical signals SE, SF, and outputs the result as a dSSa signal to the subtractor 210c. The electrical signals SG, SH from the second sub detector 115b are input to the dSS operation part 210. The adder 210b adds the electrical signals SG, SH, and outputs the result as a dSSb signal to the subtractor 210c. The dSSa signal and the dSSb signal are input to the subtractor 210c. The subtractor 210c subtracts the dSSb signal from the dSSa signal, and outputs the result as a sub beam difference signal dSS. The sub beam difference signal dSS is input to the microcomputer 111. The microcomputer 111 detects the loss-of-control of the recording/reproduction optical beam during the recording operation of the optical disc device based on the signal level of the input sub beam difference signal dSS.

According to the operation described above, when a focus loss-of-control state or a tracking loss-of-control state occurs during the recording operation, the optical disc device can detect the focus loss-of-control state or the tracking loss-of-control state with the microcomputer (loss-of-control detection unit) 111, and discontinue the recording operation.

The loss-of-control detection method during the recording operation using the sub beam difference signal dSS in Embodiment 2 is now explained.

FIG. 12 is a waveform diagram showing the change in the sub beam difference signal dSS when a loss-of-control occurs during the recording operation in Embodiment 2 of the present invention. Here, let it be assumed that the optical disc 101 is an HTL disc in which the reflectance decreases when information is recorded thereon.

During a normal recording operation to the optical disc 101 having a write-once information layer, the recording/reproduction optical beam is constantly positioned at the recording boundary, which is the boundary of the recorded region and the unrecorded region. Here, as shown in FIG. 10, the irradiating position of the preceding sub beam spot 213a is constantly in the unrecorded region, and the irradiating position of the following sub beam spot 213b is constantly in the recorded region. Accordingly, the sub beam difference signal dSS, which is the difference between the amount of reflected light from the preceding sub beam spot 213a and the amount of reflected light from the following sub beam spot 213b, becomes the difference between the amount of reflected light from the unrecorded region and the amount of reflected light from the recorded region, and, during a normal recording operation, becomes a certain signal level dSS0 as shown in FIG. 12.

Meanwhile, when a focus loss-of-control or a tracking loss-of-control occurs during the recording operation, since the recording/reproduction optical beam will deviate from the recording boundary, the irradiating position of the preceding sub beam spot 213a and the following sub beam spot 213b in a different information layer will not satisfy the foregoing relationship.

In other words, if the region of the destination to where the recording/reproduction optical beam had moved is an unrecorded region, the irradiating positions of the preceding sub beam spot 213a and the following sub beam spot 213b will both be in the same unrecorded region. In the foregoing case, the signal level of the sub beam difference signal dSS as the difference between the amount of reflected light from the preceding sub beam spot 213a and the amount of reflected light from the following sub beam spot 213b will decrease from the signal level SS0 to a signal level dSS1, and become substantially 0, as shown in FIG. 12.

Moreover, if the region of the destination to where the recording/reproduction optical beam had moved is a recorded region, the irradiating positions of the preceding sub beam spot 213a and the following sub beam spot 213b will both be in the same recorded region. In the foregoing case, the signal level of the sub beam difference signal dSS will decrease from the signal level SS0 to the signal level dSS1, and become substantially 0, as shown in FIG. 12.

Accordingly, the signal level of the sub beam difference signal dSS as the difference between the amount of reflected light from the preceding sub beam spot 213a and the amount of reflected light from the following sub beam spot 213b will change due to the focus loss-of-control or the tracking loss-of-control during the recording operation.

In Embodiment 2, the focus loss-of-control or the tracking loss-of-control during the recording operation is detected based on the change in the signal level of the sub beam difference signal dSS. In other words, the microcomputer 111 detects, during the recording operation, that the signal level of the sub beam difference signal dSS has changed from the signal level dSS0 in a normal operation to the signal level dSS1, which is substantially 0, and can thereby detect the focus loss-of-control or the tracking loss-of-control.

Accordingly, in Embodiment 2, the optical disc device can accurately detect the focus loss-of-control or the tracking loss-of-control during the recording operation using the sub beam difference signal dSS, and discontinue the recording operation. Thus, it is possible to prevent previously recorded information from being erroneously destroyed and prevent the mark sequence to be recorded from becoming discontinuous caused by the tracking loss-of-control. Consequently, the recording reliability of the optical information device can be improved.

Note that the optical disc device may also comprises a memory for pre-storing a predetermined threshold to be compared with the difference in levels of a plurality of signals output from the sub beam receiving unit 115. A predetermined threshold is, for example, a signal level between the signal level dSS0 during a normal operation and the signal level dSS1 when a focus loss-of-control or a tracking loss-of-control occurs. The microcomputer 111 may read the predetermined threshold from the memory, and compare the read predetermined threshold with the difference in levels of a plurality of signals output from the sub beam receiving unit 115. In the foregoing case, the microcomputer 111 detects the focus loss-of-control state or the tracking loss-of-control state when the difference in levels of a plurality of signals output from the sub beam receiving unit 115 is less than the predetermined threshold.

As described above, the optical disc device of Embodiment 2 is mainly configured as described below.

In other words, the optical disc device of Embodiment 2 is an optical disc device which records information by converging a main beam and a sub beam on an information layer of an information recording medium, the optical disc device comprising a focus control unit for performing control so that a convergent point of the main beam converges on a predetermined information layer, a tracking control unit for performing control so that the convergent point of the main beam scans a predetermined track or a predetermined mark sequence on an information layer, a sub beam receiving unit for receiving the sub beam reflected off the information layer and outputting a signal according to an amount of beam received, and a loss-of-control detection unit for detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal from the sub beam receiving unit.

According to the foregoing configuration, it is possible to prevent previously recorded information from being erroneously destroyed and prevent the mark sequence to be recorded from becoming discontinuous. Consequently, the recording reliability of the optical information device can be improved.

In addition, with the optical disc device of Embodiment 2, the sub beam may include a plurality of sub beams, the sub beam receiving unit may include a plurality of sub beam receiving units which respectively receive the plurality of sub beams reflected off the information layer, and the loss-of-control detection unit may detect the focus loss-of-control state or the tracking loss-of-control state when a difference in levels of a plurality of signals output from the plurality of sub beam receiving units is less than a predetermined level.

Moreover, the loss-of-control detection method of Embodiments 1 and 2 is mainly configured as follows.

In other words, the loss-of-control detection method of Embodiments 1 and 2 is a loss-of-control detection method in an optical information device which records information by converging a main beam and a sub beam on an information layer of an information recording medium. Here, the loss-of-control detection method includes a focus control step of performing control so that a convergent point of the main beam converges on a predetermined information layer, a tracking control step of performing control so that a convergent point of the main beam scans a predetermined track or a predetermined mark sequence on an information layer, a sub beam receiving step of receiving the sub beam reflected off the information layer and outputting a signal according to an amount of beam received, and a loss-of-control detection step of detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal output in the sub beam receiving step.

According to the foregoing configuration, it is possible to prevent previously recorded information from being erroneously destroyed and prevent the mark sequence to be recorded from becoming discontinuous. Consequently, the recording reliability of the optical information device can be improved.

Note that, in Embodiment 2, while the irradiating position of the main beam spot 112, the preceding sub beam spot 213a and the following sub beam spot 213b of the recording/reproduction optical beam is set to the position shown in FIG. 10, the following configuration may also be adopted.

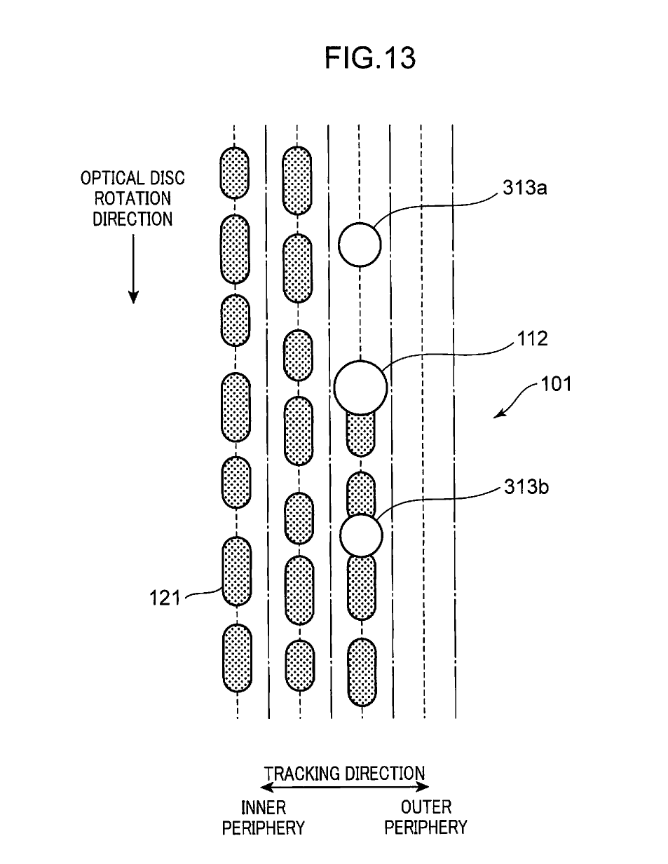

FIG. 13 is a schematic diagram showing an example of the irradiating position of the main beam spot 112, preceding sub beam spot 313a and the following sub beam spot 313b formed on the information layer of the optical disc 101 in the first modified example of Embodiment 2.

As shown in FIG. 13, when the recording/reproduction optical beam is positioned on the recording boundary during the recording operation, the preceding sub beam spot 313a is positioned in an unrecorded region on the same track radial position as the main beam spot 112, and the following sub beam spot 313b is positioned in a recorded region on the same track radial position as the main beam spot 112.

With the foregoing configuration also, the microcomputer 111 can detect the loss-of-control during the recording operation based on the change in the signal level of the sub beam difference signal dSS.

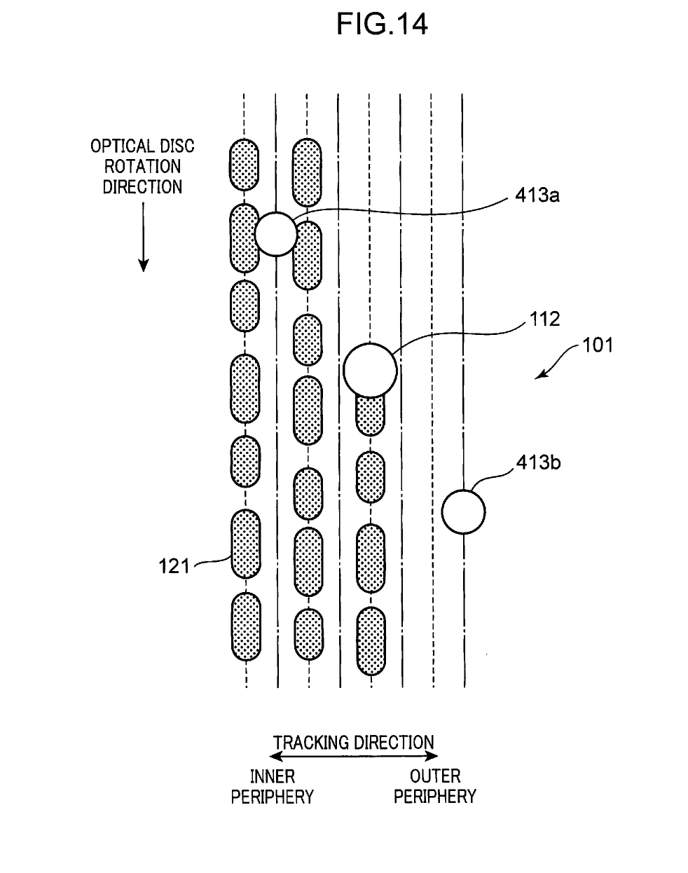

Moreover, FIG. 14 is a schematic diagram showing an example of the irradiating position of the main beam spot 112, the preceding sub beam spot 413a and the following sub beam spot 413b formed on the information layer of the optical disc 101 in the second modified example of Embodiment 2.

As shown in FIG. 14, the preceding sub beam spot 413a is positioned on an inner peripheral side by 1.5 tracks relative to the main beam spot 112, and the following sub beam spot 413b is positioned on an outer peripheral side by 1.5 tracks relative to the main beam spot 112.

With the foregoing configuration also, the microcomputer 111 can detect the loss-of-control during the recording operation based on the change in the signal level of the sub beam difference signal dSS.

Note that, in Embodiment 2, while the optical disc 101 is configured by comprising one servo layer and a plurality of information layers, the present invention is not limited to this layer structure of the optical disc 101 in the detection of the loss-of-control during the recording operation.

Note that, in Embodiment 2, while the optical disc 101 is an HTL disc, there is no particular limitation in the characteristics of the optical disc 101 in the detection of the loss-of-control during the recording operation. In other words, the optical disc 101 may also be an LTH disc. In the foregoing case, the microcomputer 111 can detect the loss-of-control during the recording operation by using the sub beam difference signal dSS.

### Embodiment 3

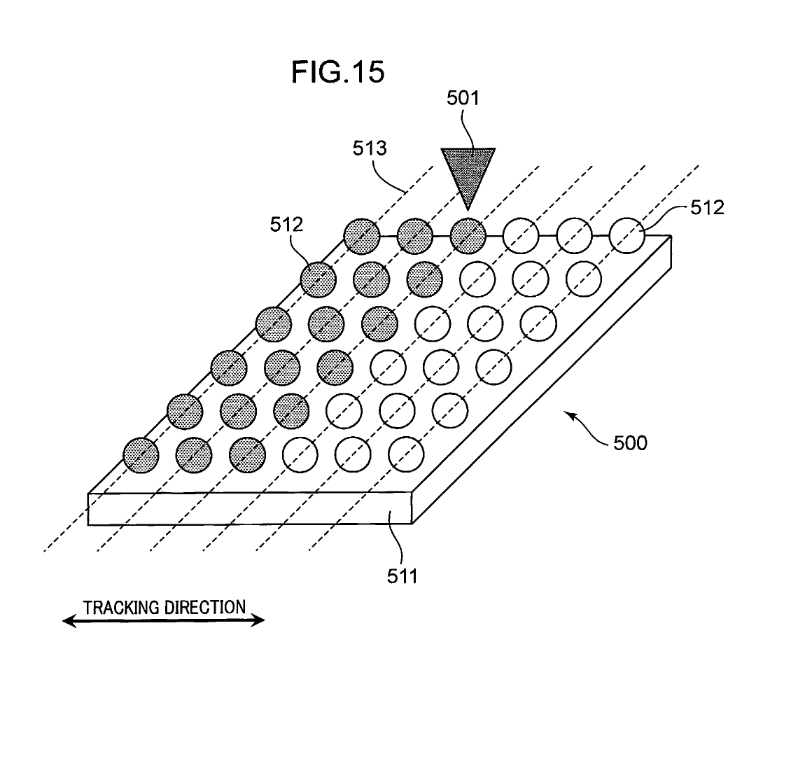

FIG. 15 is a diagram showing the configuration of the information recording medium in Embodiment 3 of the present invention.

In Embodiments 1 and 2, the configuration shown in FIG. 2 was described as an example of the information recording medium. Nevertheless, the information recording medium may also include a plurality of recording regions which are mutually isolated and disposed in sequence. For example, as shown in FIG. 15, the information recording medium 500 may include a plurality of fine particles 512 disposed in sequence on the substrate 511. A track 513 is formed as a result of the plurality of fine particles 512 being disposed in sequence.

The recording device in Embodiment 3 records information on an information recording medium 500 including a plurality of fine particles 512 which are mutually isolated and disposed in sequence as shown in FIG. 15. Note that the mutually isolated recording regions may also be fine particles. Otherwise, the mutually isolated fine particles 512 may also be columnar pillars.

Note that, in FIG. 15, the hatched fine particles 512 indicate a recorded state, and the non-hatched fine particles 512 indicate an unrecorded state.

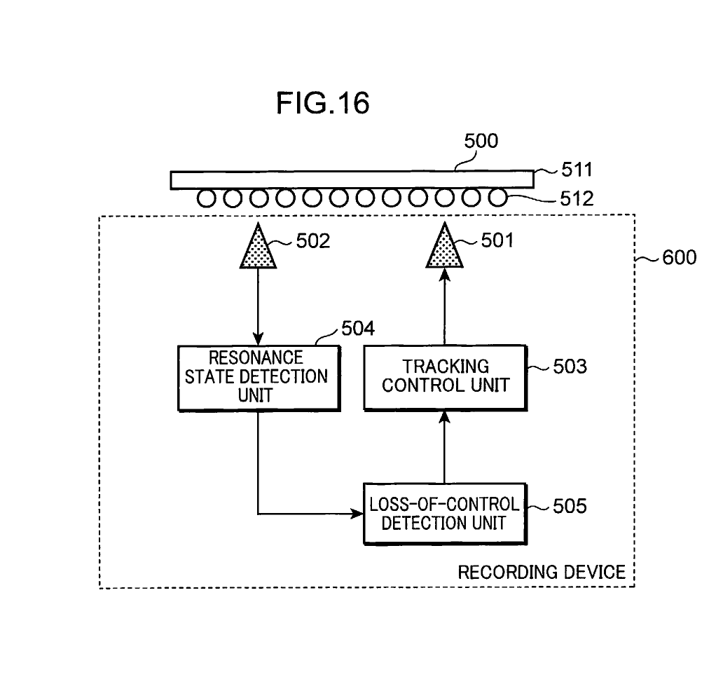

FIG. 16 is a block diagram showing the configuration of the recording device in Embodiment 3 of the present invention.

The recording device 600 in Embodiment 3 comprises a scatterer (recording unit) 501, a resonance element 502, a tracking control unit 503, a resonance state detection unit 504 and a loss-of-control detection unit 505.

The scatterer 501 records information on the fine particles (recording region) 512. The resonance state of the resonance element 502 changes according to the recording condition of the fine particles 512. The tracking control unit 503 performs control so that the scatterer 501 scans a predetermined track 513. The resonance state detection unit 504 detects the change in the resonance state of the resonance element 502 according to the recording condition of the fine particles 512, and outputs a signal according to the detected change in the resonance state. The loss-of-control detection unit 505 detects, during the recording operation of recording information, the tracking loss-of-control state of the scatterer 501 deviating from the predetermined track 513 based on the signal from the resonance state detection unit 504.

For example, the scatterer 501 records information using near-field light. The scatterer 501 is configured, for example, from fine metals of a nano-scale, and excites a plasmon by generating collective oscillation to the free electrons in the metal by being irradiated with light. As a result of exciting the plasmon, it is possible to obtain a strong electromagnetic field that was locally enhanced. As a result of applying this phenomenon, the local plasmon is excited as a result light entering the scatterer 501, and an optical electric-field (near-field light) near the scatterer 501 is locally enhanced. In addition, by using the foregoing near-field light, information can be recorded in a minute region of a nano-meter order which exceeds the diffraction limit.

As the scatterer 501, for example, metal materials such as gold, silver, platinum, aluminum or chromium may also be used. Moreover, the scatterer 501 may also be an antenna having a triangular shape as shown in FIG. 16. Otherwise, the shape of the scatterer 501 may also be a cylindrical shape.

Note that, while the scatterer 501 was illustrated as a specific example of the recording unit, the present invention is not limited thereto. For example, the recording unit may also be a recording unit that uses magnetism. Any recording unit may be used so as long as it can change the recording condition of the fine particles 512.

The resonance state of the resonance element 502 changes according to the recording condition of the fine particles 512. For example, the level of plasmon resonance of the resonance element 502 and the fine particles 512 near the resonance element 502 will change according to whether the fine particles 512 are of a recorded state or an unrecorded state.

As the resonance element 502, for example, metal materials such as gold, silver, platinum, aluminum or chromium may also be used. Moreover, the resonance element 502 may also be an antenna having a triangular shape as shown in FIG. 16. Otherwise, the shape of the resonance element 502 may also be a cylindrical shape.

The fine particles 512 of the information recording medium 500 in Embodiment 3 contain a material that changes the foregoing resonance state with the resonance element 502 in accordance with the recording condition. For example, the fine particles 512 of the information recording medium 500 in Embodiment 3 may contain a dielectric material, or a material containing metal.

Otherwise, the fine particles 512 may also contain a phase change material. Consequently, for example, as a result of the fine particles 512 being irradiated with near-field light by the scatterer 501, the fine particles 512 will change to an amorphous state or a crystal state. By using this phenomenon, for example, information can be recorded on the fine particles 512 with each of the fine particles 512 as a single unit. For example, the recording condition may correspond to a crystal state and the unrecorded state may correspond to an amorphous state. Otherwise, contrarily, the recording condition may correspond to an amorphous state and the unrecorded state may correspond to a crystal state.

The resonance state detection unit 504 detects the change in the resonance state of the resonance element 502 according to the recording condition of the fine particles 512. The reflected light or the transmitted light of the light with which the resonance element 502 was irradiated will change based on the resonance state of the resonance element 502. Accordingly, for example, by using the foregoing phenomenon, the resonance state detection unit 504 can detect the change in the resonance state of the resonance element 502. As a result of the resonance element 502 being irradiated with light and the change in the reflected light or the transmitted light from the resonance element 502 being detected, the resonance state detection unit 504 detects the change in the resonance state of the resonance element 502.

The recording device 600 in Embodiment 3 detects the tracking loss-of-control during the recording operation of the recording device 600 based on the change in the resonance state of the resonance element 502 according to the recording condition of the fine particles 512.

It is thereby possible to accurately detect the tracking loss-of-control. Thus, it is possible to prevent previously recorded information from being erroneously destroyed and prevent the mark sequence to be recorded from becoming discontinuous caused by the tracking loss-of-control. Consequently, the recording reliability of the optical information device can be improved.

Note that, in Embodiment 3, the recording device corresponds to an example of the optical information device, the scatterer 501 corresponds to an example of the recording unit, the resonance element 502 corresponds to an example of the resonance element, the tracking control unit 503 corresponds to an example of the tracking control unit, the resonance state detection unit 504 corresponds to an example of the resonance state detection unit, and the loss-of-control detection unit 505 corresponds to an example of the loss-of-control detection unit.

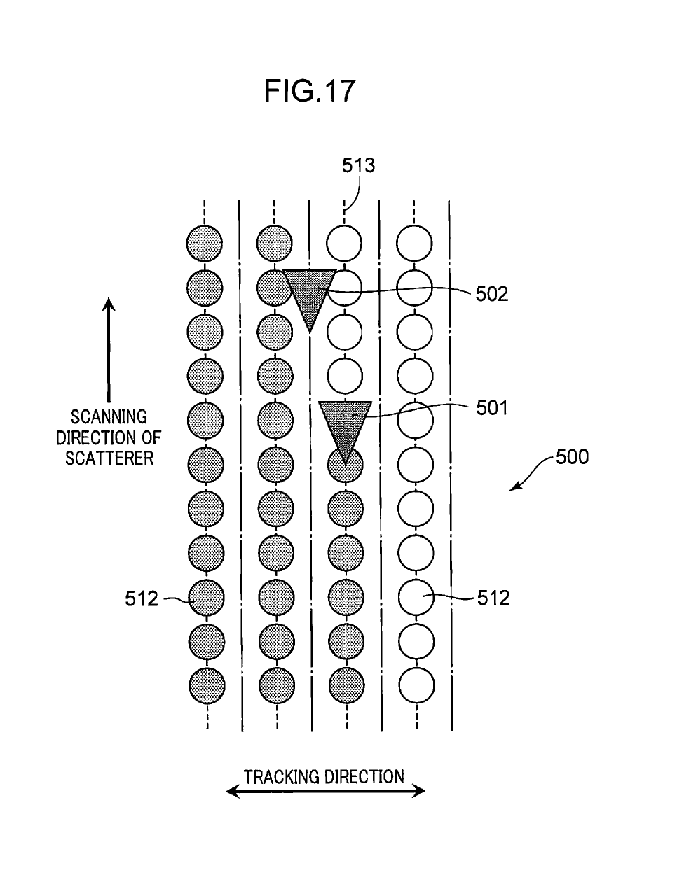

FIG. 17 is a schematic diagram showing an example of the arrangement of the scatterer and the resonance element in Embodiment 3. Note that, in FIG. 17, the hatched fine particles 512 indicate a recorded state, and the non-hatched fine particles 512 indicate an unrecorded state.

In FIG. 17, the direction from up to down on the plane of paper is the scanning direction of the scatterer 501 and the resonance element 502. Here, the recording device 600 may also cause the scatterer 501 and the resonance element 502 to scan the information recording medium by rotating the information recording medium 500 as in an optical disc device. Otherwise, the recording device 600 may also comprise a move part for moving the scatterer 501 and the resonance element 502. In other words, it is also possible to cause the scatterer 501 and resonance element 502 to scan the information recording medium 500 as a result of moving the scatterer 501 and the resonance element 502 by using the move part.

In FIG. 17, the horizontal direction of the plane of paper is the tracking direction. When the information recording medium 500 is of a disc shape, for example, the left direction of the plane of paper is the inner peripheral direction, and the right direction of the plane of paper is the outer peripheral direction. Moreover, in FIG. 17, the broken line indicates the center of the track 513. The dashed line indicates the intermediate position of two adjacent tracks.

As shown in FIG. 17, the resonance element 502 is disposed at a position that is displaced by a distance that is half the track pitch (0.5 tracks) in the tracking direction relative to the scatterer 501. The resonance element 502 is disposed on a boundary of a recorded region where information is recorded and an unrecorded region where information is not recorded.

The detection method of the tracking loss-of-control using the resonance element 502 shown in FIG. 17 is now explained.

Let it be assumed that the level of the signal from the resonance state detection unit 504 when the tracking control is normal is a first signal level RS1. Here, let it be assumed that a tracking loss-of-control has occurred and the positions of the scatterer 501 and the resonance element 502 has shifted in the tracking direction. When the resonance element 502 approaches the fine particles 512 in a recorded state due to the tracking loss-of-control, the level of the signal from the resonance state detection unit 504 will change to a second signal level RS2 which is different from the first signal level RS1. Meanwhile, when the resonance element 502 approaches the fine particles 512 in an unrecorded state due to the tracking loss-of-control, the level of the signal from the resonance state detection unit 504 will change to a third signal level RS3 which is different from the first signal level RS1 and the second signal level RS2.

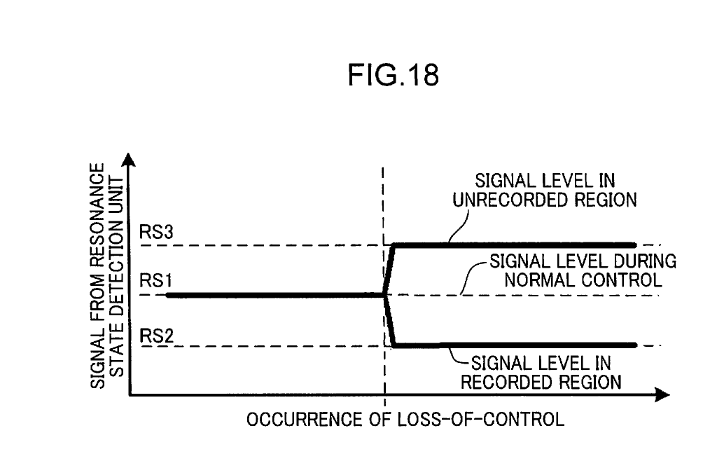

FIG. 18 is a waveform diagram showing the change in the signal from the resonance state detection unit when the tracking loss-of-control occurs during the recording operation in Embodiment 3 of the present invention.

As shown in FIG. 18, when the tracking state is normal, the level of the signal from the resonance state detection unit 504 will be the first signal level RS1. Here, when a tracking loss-of-control occurs during the recording operation and the resonance element 502 approaches the fine particles 512 in a recorded state, the level of the signal from the resonance state detection unit 504 will change to the second signal level RS2 that is higher than the first signal level RS1. Meanwhile, when the resonance element 502 approaches the fine particles 512 in an unrecorded state due to the tracking loss-of-control, the level of the signal from the resonance state detection unit 504 will change to the third signal level RS3 that is lower than the first signal level RS1.

The loss-of-control detection unit 505 detects the tracking loss-of-control state when the level of the signal from the resonance state detection unit 504 changes to a level of the resonance state in a recorded region where information is recorded or a level of the resonance state in an unrecorded region where information is not recorded.

Note that, when the resonance element 502 approaches the fine particles 512 in a recorded state based on the resonance state, the level of the signal from the resonance state detection unit 504 may change to a second signal level that is lower than the first signal level. Moreover, when the resonance element 502 approaches the fine particles 512 in an unrecorded state based on the resonance state, the level of the signal from the resonance state detection unit 504 may change to a third signal level that is higher than the first signal level.

As described above, the loss-of-control detection unit 505 can detect the tracking loss-of-control state during the recording operation of the recording device 600 by using the change in the level of the signal from the resonance state detection unit 504.

Note that the recording device 600 may comprise a memory for pre-storing the third signal level RS3 indicating the resonance state in an unrecorded region where information is not recorded, and the second signal level RS2 indicating the resonance state in a recorded region where information is recorded. The loss-of-control detection unit 505 may read the third signal level RS3 and the second signal level RS2 from the memory, and compare the read third signal level RS3 and the second signal level RS2 with the level of the signal from the resonance state detection unit 504. In the foregoing case, the loss-of-control detection unit 505 can detect the tracking loss-of-control state when the level of the signal from the resonance state detection unit 504 is the third signal level RS3 or the second signal level RS2.

Note that the recording device in Embodiment 3 may further comprise a holding part for holding the scatterer 501 and the resonance element 502. The holding part may also fix the positions of the scatterer 501 and the resonance element 502. Consequently, when a position gap arises in the scatterer due to the tracking loss-of-control, the same position gap can also be generated in the resonance element 502.

Note that the arrangement of the scatterer 501 and the resonance element 502 is not limited to the arrangement shown in FIG. 17.

In other words, the resonance element 502 is not limited to being displaced by 0.5 tracks in the tracking direction relative to the scatterer 501, and may be separated by a predetermined distance in the tracking direction relative to the scatterer 501.

Moreover, the resonance element 502 and the scatterer 501 do not need to be displaced relative to the scanning direction of the scatterer 501.

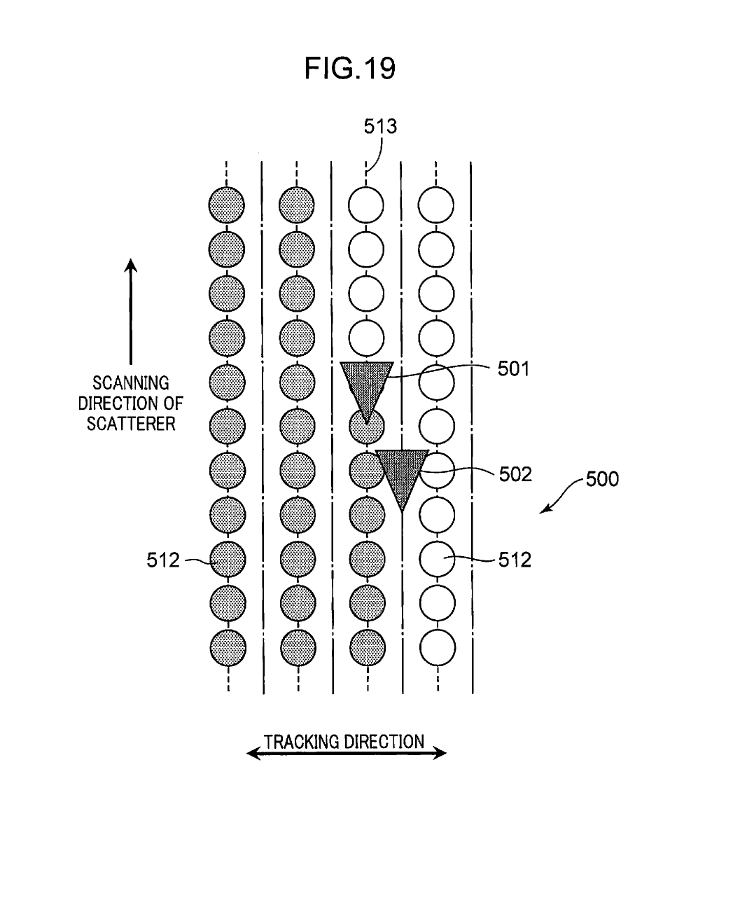

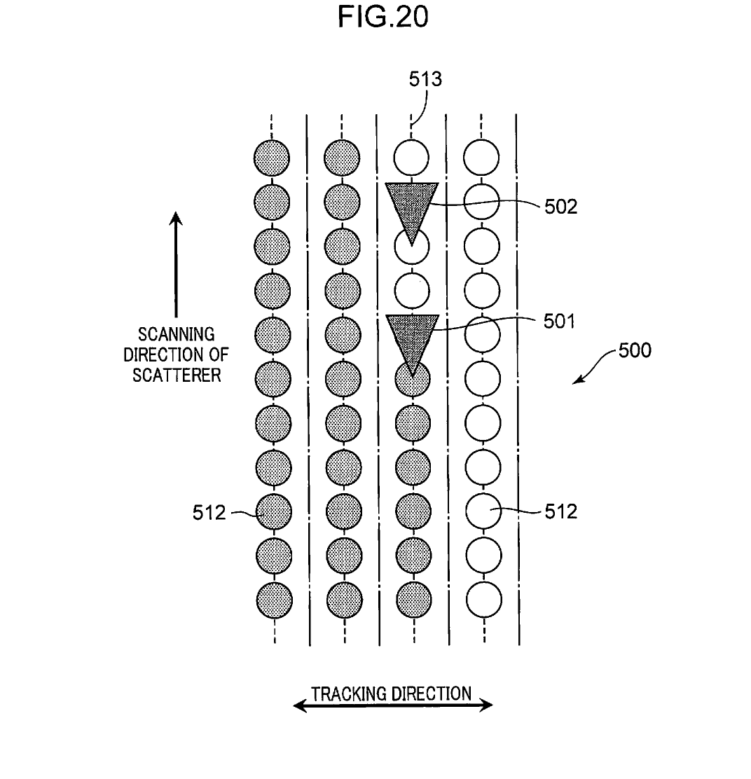

Moreover, the arrangement of the scatterer 501 and the resonance element 502 may also be, for example, the arrangement shown in FIG. 19. FIG. 19 is a schematic diagram showing an example of the arrangement of the scatterer and the resonance element in the first modified example of Embodiment 3.

For example, as shown in FIG. 19, the displacement of the resonance element 502 relative to the scatterer 501 in the tracking direction may be the displacement in a direction where the fine particles 512 in an unrecorded state exist. Here, the resonance element 502 may also be displaced by a predetermined distance in the tracking direction relative to the scatterer 501.

Moreover, for example, as shown in FIG. 19, the resonance element 502 may also be separated by a predetermined distance in a direction that is opposite to the scanning direction of the scatterer 501 relative to the scatterer 501. Otherwise, the resonance element 502 and the scatterer 501 do not need to be displaced relative to the scanning direction of the scatterer 501.

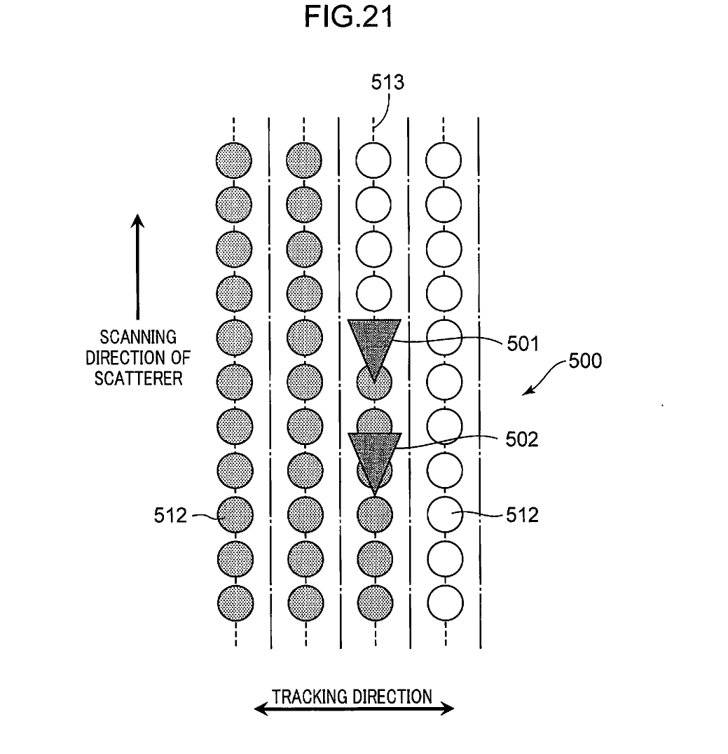

Moreover, the arrangement of the scatterer 501 and the resonance element 502 may also be, for example, the arrangement shown in FIG. 20 or FIG. 21. FIG. 20 is a schematic diagram showing an example of the arrangement of the scatterer and the resonance element in the second modified example of Embodiment 3. FIG. 21 is a schematic diagram showing an example of the arrangement of the scatterer and the resonance element in the third modified example of Embodiment 3.

As shown in FIG. 20 and FIG. 21, the resonance element 502 and the scatterer 501 do not need to be displaced in the tracking direction.

For example, as shown in FIG. 20, the resonance element 502 may also be disposed near the fine particles 512 in an unrecorded state on the same track as the scatterer 501. According to this configuration, it is possible to accurately detect that the scatterer 501 erroneously moved, due to the tracking loss-of-control, to a region where the fine particles 512 in a recorded state exist.

Otherwise, as shown in FIG. 21, the resonance element 502 may also be disposed near the fine particles 512 in an recorded state on the same track as the scatterer 501. According to this configuration, it is possible to accurately detect that the scatterer 501 erroneously moved, due to the tracking loss-of-control, to a region where the fine particles 512 in an unrecorded state exist.

In other words, the loss-of-control detection unit 505 detects the tracking loss-of-control state when the level of the signal from the resonance state detection unit 504 changes from a level of the resonance state in a recorded region where information is recorded to a level of the resonance state in an unrecorded region where information is not recorded or from a level of the resonance state in the unrecorded region to a level of the resonance state in the recorded region.

### Embodiment 4

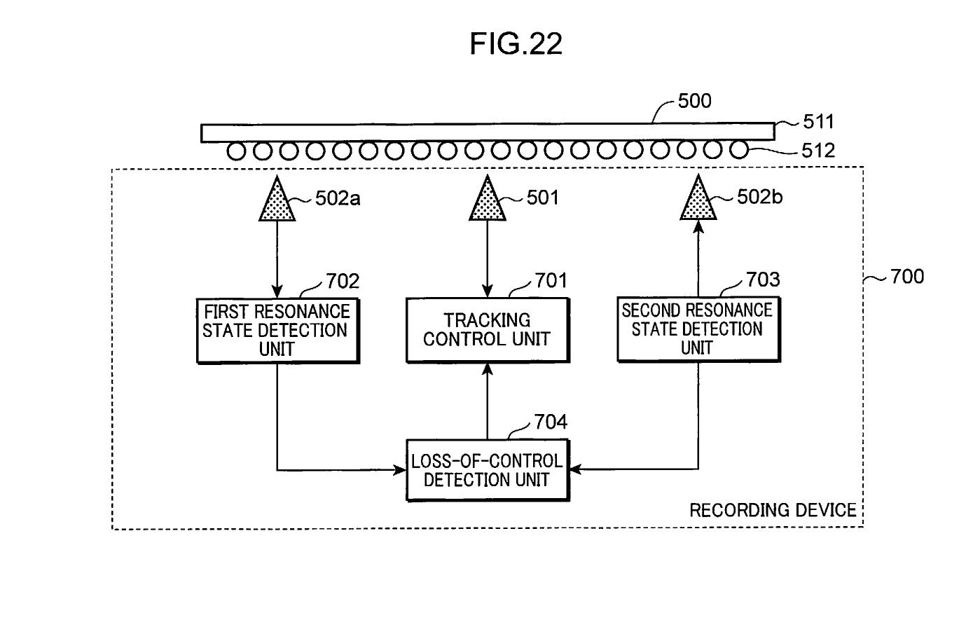

FIG. 22 is a block diagram showing the configuration of the recording device in Embodiment 4 of the present invention.

As shown in FIG. 22, the recording device 700 in Embodiment 4 comprises a scatterer (recording unit) 501, a first resonance element 502a, a second resonance element 502b, a tracking control unit 701, a first resonance state detection unit 702, a second resonance state detection unit 703 and a loss-of-control detection unit 704.

The resonance state of the first resonance element 502a changes according to the recording condition of the fine particles 512. The second resonance element 502b is disposed at a position that is different from the first resonance element 502a, and the resonance state changes according to the recording condition of the fine particles 512.

The tracking control unit 701 performs control so that the scatterer 501 scans a predetermined track. The first resonance state detection unit 702 detects the change in the resonance state of the first resonance element 502a according to the recording condition of the fine particles 512, and outputs a signal according to the detected change in the resonance state. The second resonance state detection unit 703 detects the change in the resonance state of the second resonance element 502b according to the recording condition of the fine particles 512, and outputs a signal according to the detected change in the resonance state.

The loss-of-control detection unit 704 detects the tracking loss-of-control state when the difference between a level of the signal output from the first resonance state detection unit 702 and a level of the signal output from the second resonance state detection unit 703 is less than a predetermined level.

The resonance state of the second resonance element 502b changes according to the recording condition of the fine particles 512. For example, the level of plasmon resonance of the second resonance element 502b and the fine particles 512 near the second resonance element 502b will change according to whether the fine particles 512 are of a recorded state or an unrecorded state.

As the first resonance element 502a and the second resonance element 502b, for example, metal materials such as gold, silver, platinum, aluminum or chromium may also be used. Moreover, the first resonance element 502a and the second resonance element 502b may also be an antenna having a triangular shape as shown in FIG. 22. Otherwise, the shape of the first resonance element 502a and the second resonance element 502b may also be a cylindrical shape.

The second resonance state detection unit 703 detects the change in the resonance state of the second resonance element 502b according to the recording condition of the fine particles 512. The reflected light or the transmitted light of the light with which the resonance element was irradiated will change based on the resonance state of the resonance element. Accordingly, for example, by using the foregoing phenomenon, the second resonance state detection unit 703 can detect the change in the resonance state of the second resonance element 502b. As a result of the second resonance element 502b being irradiated with light and the change in the reflected light or the transmitted light from the second resonance element 502b being detected, the second resonance state detection unit 703 detects the change in the resonance state of the second resonance element 502b.

Note that, in Embodiment 4, the recording device 700 corresponds to an example of the optical information device, the scatterer 501 corresponds to an example of the recording unit, the first resonance element 502a corresponds to an example of the first resonance element, the second resonance element 502b corresponds to an example of the second resonance element, the tracking control unit 701 corresponds to an example of the tracking control unit, the first resonance state detection unit 702 corresponds to an example of the first resonance state detection unit, the second resonance state detection unit 703 corresponds to an example of the second resonance state detection unit, and the loss-of-control detection unit 704 corresponds to an example of the loss-of-control detection unit.

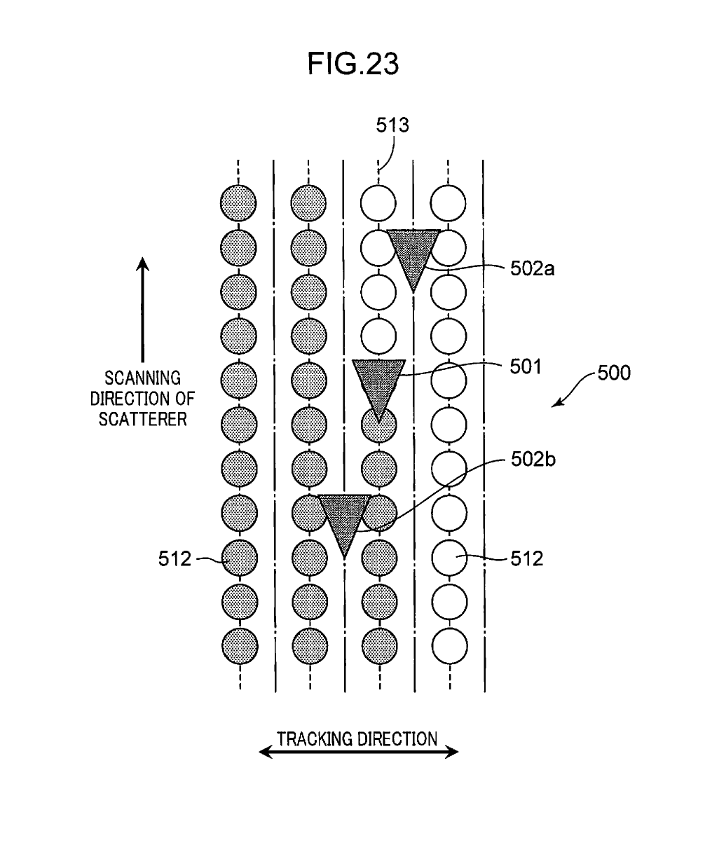

FIG. 23 is a schematic diagram showing an example of the arrangement of the scatterer, the first resonance element and the second resonance element in Embodiment 4.

As shown in FIG. 23, the first resonance element 502a is disposed at a position that is displaced by a distance that is half the track pitch (0.5 tracks) to the side where the fine particles 512 in an unrecorded state exist in the tracking direction relative to the scatterer 501. In addition, the second resonance element 502b is disposed at a position that is displaced by a distance that is half the track pitch (0.5 tracks) to the side where the fine particles 512 in a recorded state exist in the tracking direction relative to the scatterer 501.

The detection method of the tracking loss-of-control using the first resonance element 502a and the second resonance element 502b shown in FIG. 23 is now explained.

Let it be assumed that the difference between the level of the signal from the first resonance state detection unit 702 and the level of the signal from the second resonance state detection unit 703 when the tracking control is normal is a first difference signal level. Here, let it be assumed that a tracking loss-of-control has occurred and the positions of the scatterer 501, the first resonance element 502a and the second resonance element 502b has shifted in the tracking direction. When both the first resonance element 502a and the second resonance element 502b approach the fine particles 512 in a recorded state due to the tracking loss-of-control, the difference between the level of the signal from the first resonance state detection unit 702 and the level of the signal from the second resonance state detection unit 703 will change to a second difference signal level that is different from the first difference signal level.

Meanwhile, when both the first resonance element 502a and the second resonance element 502b approach the fine particles 512 in an unrecorded state due to the tracking loss-of-control, the difference between the level of the signal from the first resonance state detection unit 702 and the level of the signal from the second resonance state detection unit 703 will change to a third difference signal level that is different from the first difference signal level.

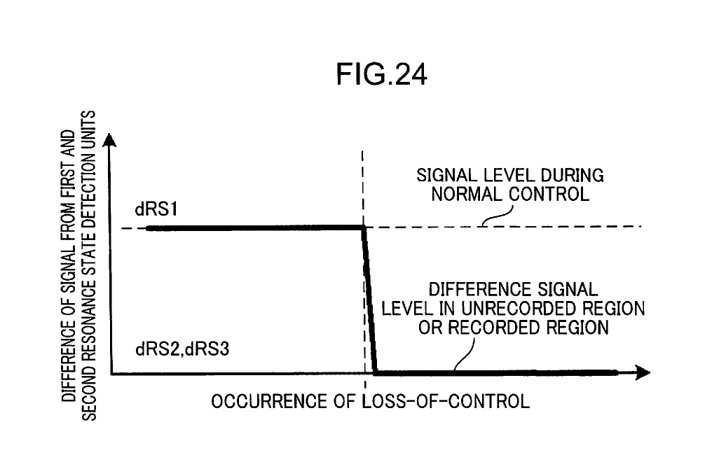

FIG. 24 is a waveform diagram showing the change in the difference in the level of the signal from the first resonance state detection unit and the level of the signal from the second resonance state detection unit when the tracking loss-of-control occurs during the recording operation in Embodiment 4 of the present invention.

As shown in FIG. 24, when the tracking state is normal, the difference between the level of the signal from the first resonance state detection unit 702 and the level of the signal from the second resonance state detection unit 703 will be a first difference signal level dRS1. Here, when a tracking loss-of-control occurs during the recording operation and the first resonance element 502a and the second resonance element 502b approach the fine particles 512 in a recorded state, the difference between the level of the signal from the first resonance state detection unit 702 and the level of the signal from the second resonance state detection unit 703 will change to a second difference signal level dRS2 that is lower than the first difference signal level dRS1. Meanwhile, when the first resonance element 502a and the second resonance element 502b approach the fine particles 512 in an unrecorded state due to the tracking loss-of-control, the difference between the level of the signal from the first resonance state detection unit 702 and the level of the signal from the second resonance state detection unit 703 will change to a third difference signal level dRS3 that is lower than the first difference signal level dRS1.

Here, both the second difference signal level dRS2 and the third difference signal level dRS3 are substantially 0. In other words, the difference between the level of the signal from the first resonance state detection unit 702 and the level of the signal from the second resonance state detection unit 703 will be less than a predetermined level.

As described above, the loss-of-control detection unit 704 can detect the tracking loss-of-control during the recording operation of the recording device 700 by using the change in the difference between the level of the signal from the first resonance state detection unit 702 and the level of the signal from the second resonance state detection unit 703.

It is thereby possible to more accurately detect the tracking loss-of-control. Thus, it is possible to prevent previously recorded information from being erroneously destroyed and prevent the mark sequence to be recorded from becoming discontinuous caused by the tracking loss-of-control. Consequently, the recording reliability of the optical information device can be improved.

Note that the recording device 700 comprise a memory for pre-storing a predetermined threshold to be compared with the difference between the level of the signal from the first resonance state detection unit 702 and the level of the signal from the second resonance state detection unit 703. A predetermined threshold is, for example, a signal level between the first difference signal level dRS1 indicating the difference between the level of the signal from the first resonance state detection unit 702 and the level of the signal from the second resonance state detection unit 703 in a normal operation, and the second or third difference signal level dRS2 or dRS3 indicating the difference between the level of the signal from the first resonance state detection unit 702 and the level of the signal from the second resonance state detection unit 703 when a tracking loss-of-control occurs. The loss-of-control detection unit 704 may read the predetermined threshold from the memory, and compare the read predetermined threshold with the difference between the level of the signal from the first resonance state detection unit 702 and the level of the signal from the second resonance state detection unit 703. In the foregoing case, the loss-of-control detection unit 704 detects the tracking loss-of-control state when the difference between the level of the signal from the first resonance state detection unit 702 and the level of the signal from the second resonance state detection unit 703 is less than the predetermined threshold.

Moreover, the loss-of-control detection unit 704 may also detect the tracking loss-of-control state when the sum of the level of the signal from the first resonance state detection unit 702 and the level of the signal from the second resonance state detection unit 703 changes to a level of the resonance state in a recorded region where information is recorded or a level of the resonance state in an unrecorded region where information is not recorded.

Note that the recording device in Embodiment 4 may further comprise a holding part for holding the scatterer 501 and the first resonance element 502a and the second resonance element 502b. The holding part may also fix the positions of the scatterer 501 and the first resonance element 502a and the second resonance element 502b. Consequently, when a position gap arises in the scatterer 501 due the tracking loss-of-control, the same position gap can also be generated in the first resonance element 502a and the second resonance element 502b.

Note that the arrangement of the scatterer 501 and the first resonance element 502a and the second resonance element 502b may also adopt the following configuration.

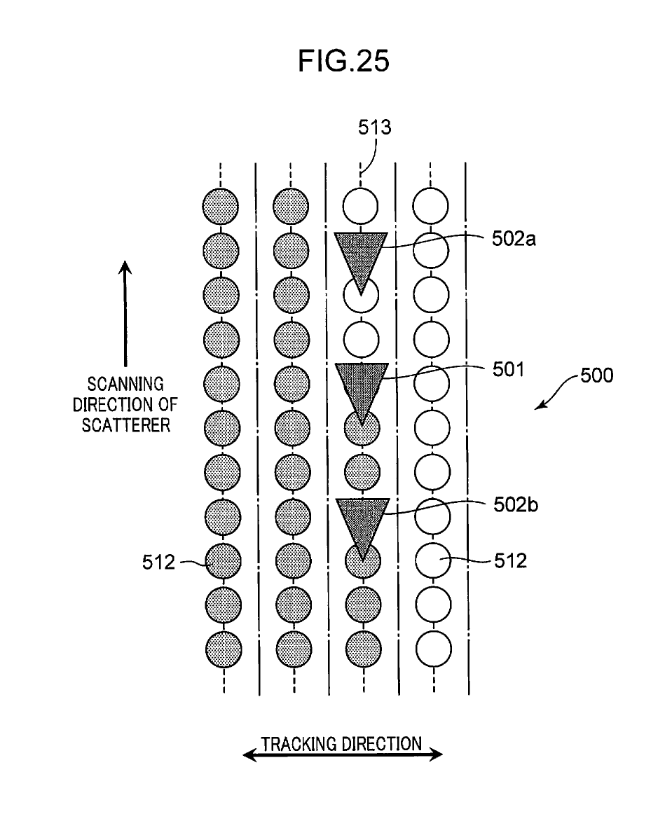

FIG. 25 is a schematic diagram showing an example of the arrangement of the scatterer, the first resonance element and the second resonance element in the first modified example of Embodiment 4.

As shown in FIG. 25, the first resonance element 502a is disposed near the fine particles 512 in an unrecorded state on the same track as the scatterer 501. In addition, the second resonance element 502b is disposed near the fine particles 512 in a recorded state on the same track as the scatterer 501.

Even when the scatterer 501, the first resonance element 502a and the second resonance element 502b are disposed as shown in FIG. 25, the loss-of-control detection unit 704 can detect the tracking loss-of-control during the recording operation of the recording device 700 by using the change in the difference between the level of the signal from the first resonance state detection unit 702 and the level of the signal from the second resonance state detection unit 703.

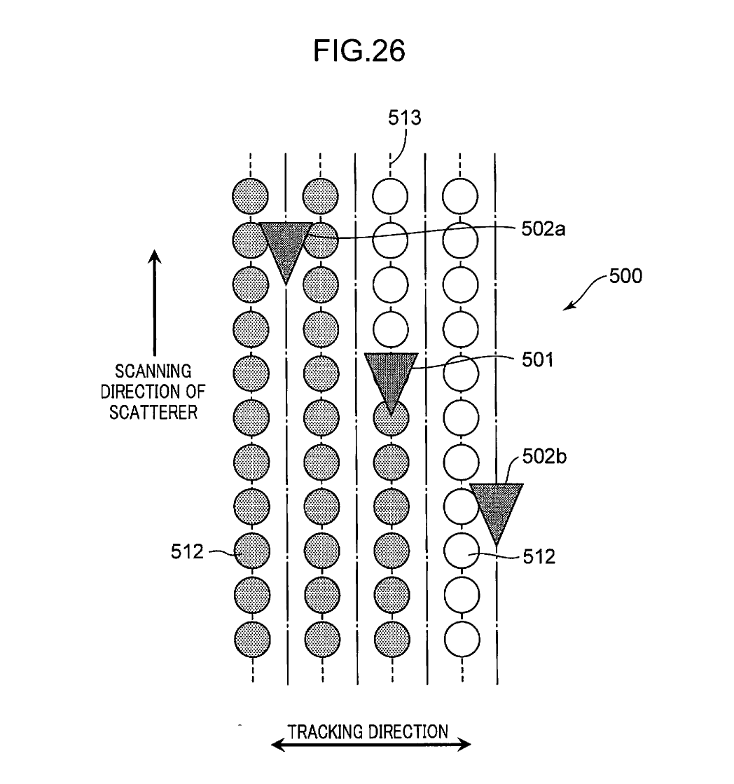

FIG. 26 is a schematic diagram showing an example of the arrangement of the scatterer, the first resonance element and the second resonance element in the second modified example of Embodiment 4.

As shown in FIG. 26, the first resonance element 502a is disposed at a position that is displaced by a predetermined distance (for example, 1.5 tracks) to a side where the fine particles 512 in a recorded state exist in the tracking direction relative to the scatterer 501. In addition, the second resonance element 502b is disposed at a position that is displaced by a predetermined distance (for example, 1.5 tracks) to a side where the fine particles 512 in an unrecorded state exist in the tracking direction relative to the scatterer 501.

Even when the scatterer 501, the first resonance element 502a and the second resonance element 502b are disposed as shown in FIG. 26, the loss-of-control detection unit 704 can detect the tracking loss-of-control during the recording operation of the recording device 700 by using the change in the difference between the level of the signal from the first resonance state detection unit 702 and the level of the signal from the second resonance state detection unit 703.

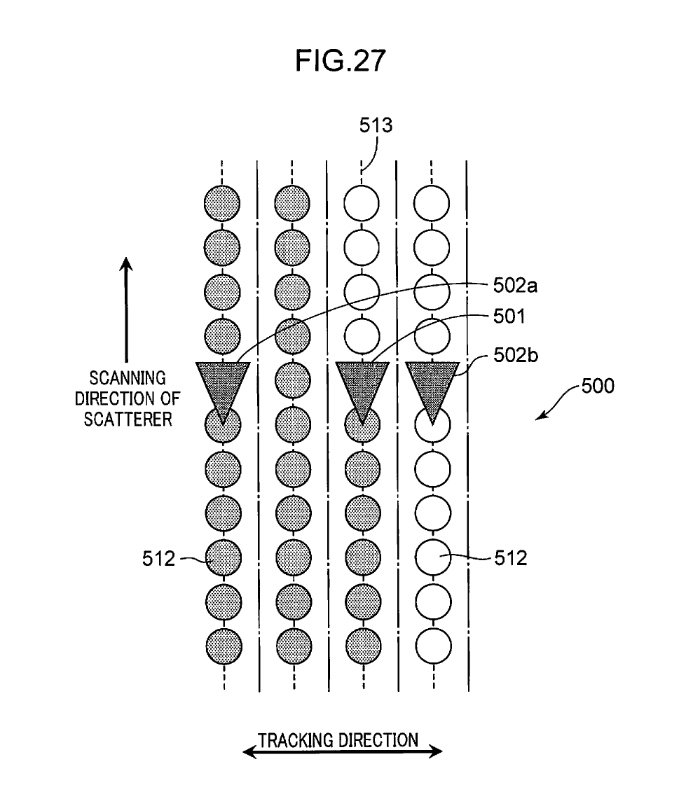

FIG. 27 is a schematic diagram showing an example of the arrangement of the scatterer, the first resonance element and the second resonance element in the third modified example of Embodiment 4.

As shown in FIG. 27, the first resonance element 502a and the scatterer 501 are not displaced relative to the scanning direction of the scatterer 501. Moreover, the second resonance element 502b and the scatterer 501 are not displaced relative to the scanning direction of the scatterer 501.

As shown in FIG. 27, the first resonance element 502a is disposed at a position that is displaced by a predetermined distance (for example, 2 tracks) to a side where the fine particles 512 in a recorded state exist in the tracking direction relative to the scatterer 501. In addition, the second resonance element 502b is disposed at a position that is displaced by a predetermined distance (for example, 1 track) to a side where the fine particles 512 in an unrecorded state exist in the tracking direction relative to the scatterer 501.

Even when the scatterer 501, the first resonance element 502a and the second resonance element 502b are disposed as shown in FIG. 27, the loss-of-control detection unit 704 can detect the tracking loss-of-control during the recording operation of the recording device 700 by using the change in the difference between the level of the signal from the first resonance state detection unit 702 and the level of the signal from the second resonance state detection unit 703.

As shown in FIG. 23, FIG. 25, FIG. 26 and FIG. 27, the arrangement of the scatterer 501 and the first resonance element 502a and the second resonance element 502b may also adopt the following configuration.

In other words, the first resonance element 502a and the scatterer 501 may or may not be displaced relative to the scanning direction of the scatterer 501. Moreover, the second resonance element 502b and the scatterer 501 may or may not be displaced relative to the scanning direction of the scatterer 501. Otherwise, only one of either the first resonance element 502a or the second resonance element 502b may be displaced relative to the scanning direction of the scatterer 501.

Moreover, the first resonance element 502a may or may not be displaced to one side of the tracking direction relative to the scatterer 501. Moreover, the second resonance element 502b may or may not be displaced to the other side of the tracking direction relative to the scatterer 501. Otherwise, only one of either the first resonance element 502a or the second resonance element 502b may be displaced in the tracking direction.

Moreover, the amount of displacement of the first resonance element 502a to one side of the tracking direction relative to the scatterer 501 and the amount of displacement of the second resonance element 502b to the other side of the tracking direction relative to the scatterer 501 may be the same amount. Otherwise, the amount of displacement of the first resonance element 502a to one side of the tracking direction relative to the scatterer 501 and the amount of displacement of the second resonance element 502b to the other side of the tracking direction relative to the scatterer 501 may be a different amount.

As described above, the configuration will suffice so as long as one of either the first resonance element 502a or the second resonance element 502b is disposed in a region where the fine particles 512 in a recorded state exist, and the other of either the first resonance element 502a or the second resonance element 502b is disposed in a region where the fine particles 512 in an unrecorded state exist.

Note that the specific embodiments described above mainly include the invention configured as described below.

The optical information device according to one aspect of the present invention is an optical information device which records information by converging a main beam and a sub beam on an information layer of an information recording medium, the device comprising a focus control unit for performing control so that a convergent point of the main beam converges on a predetermined information layer, a tracking control unit for performing control so that the convergent point of the main beam scans a predetermined track or a predetermined mark sequence on an information layer, a sub beam receiving unit for receiving the sub beam reflected off the information layer and outputting a signal according to an amount of beam received, and a loss-of-control detection unit for detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal from the sub beam receiving unit.

According to the foregoing configuration, the focus control unit performs control so that a convergent point of the main beam converges on a predetermined information layer. The tracking control unit performs control so that the convergent point of the main beam scans a predetermined track or a predetermined mark sequence on an information layer. The sub beam receiving unit receives the sub beam reflected off the information layer and outputs a signal according to an amount of beam received. The loss-of-control detection unit detects, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal from the sub beam receiving unit.

Accordingly, since the focus loss-of-control state or the tracking loss-of-control state is detected, it is possible to prevent previously recorded information from being erroneously destroyed and prevent the mark sequence to be recorded from becoming discontinuous and, consequently, the recording reliability of the optical information device can be improved.

Moreover, in the foregoing optical information device, preferably, the loss-of-control detection unit detects the focus loss-of-control state or the tracking loss-of-control state when a level of a signal output from the sub beam receiving unit is a reflected light level from a recorded region where information is recorded or a reflected light level from an unrecorded region where information is not recorded.

According to the foregoing configuration, the focus loss-of-control state or the tracking loss-of-control state is detected when a level of the signal output from the sub beam receiving unit is a reflected light level from a recorded region where information is recorded or a reflected light level from an unrecorded region where information is not recorded.

Accordingly, the focus loss-of-control state or the tracking loss-of-control state can be easily detected by the level of the signal output from the sub beam receiving unit being compared with the reflected light level from the recorded region or the reflected light level from the unrecorded region.

Moreover, in the foregoing optical information device, preferably, the sub beam includes a plurality of sub beams, the sub beam receiving unit includes a plurality of sub beam receiving units which respectively receive the plurality of sub beams reflected off the information layer, and the loss-of-control detection unit detects the focus loss-of-control state or the tracking loss-of-control state when a sum of levels of a plurality of signals output from the plurality of sub beam receiving units is a reflected light level from a recorded region where information is recorded or a reflected light level from an unrecorded region where information is not recorded.

According to the foregoing configuration, the sub beam includes a plurality of sub beams. The plurality of sub beam receiving units respectively receive the plurality of sub beams reflected off the information layer. In addition, the focus loss-of-control state or the tracking loss-of-control state is detected when a sum of levels of a plurality of signals output from the plurality of sub beam receiving units is a reflected light level from a recorded region where information is recorded or a reflected light level from an unrecorded region where information is not recorded.

Accordingly, the focus loss-of-control state or the tracking loss-of-control state can be easily detected by the sum of levels of a plurality of signals output from the plurality of sub beam receiving units being compared with the reflected light level from the recorded region or the reflected light level from the unrecorded region.

Moreover, in the foregoing optical information device, preferably, the plurality of sub beams include a first sub beam which converges on a recorded region side where information is recorded when the main beam is converged at a center of the track, and a second sub beam which converges on an unrecorded region side where information is not recorded when the main beam is converged at the center of the track.

According to the foregoing configuration, the sub beams include a first sub beam which converges on a recorded region side where information is recorded when the main beam is converged at a center of the track, and a second sub beam which converges on an unrecorded region side where information is not recorded when the main beam is converged at the center of the track.

Accordingly, the focus loss-of-control state or the tracking loss-of-control state can be reliably detected by using the first sub beam reflected off the information layer and the second sub beam reflected off the information layer.

Moreover, in the foregoing optical information device, preferably, the loss-of-control detection unit detects the focus loss-of-control state or the tracking loss-of-control state when a level of a signal from the sub beam receiving unit changes from a reflected light level from a recorded region where information is recorded to a reflected light level from an unrecorded region where information is not recorded, or when the level of the signal changes from a reflected light level from the unrecorded region to a reflected light level from the recorded region.

According to the foregoing configuration, when the optical beam is split into a main beam and one sub beam, and the one sub beam converges on a recorded region side where information is recorded when the main beam is converged at the center of the track, the focus loss-of-control state or the tracking loss-of-control state is detected when the level of the signal from the sub beam receiving unit changes from a reflected light level from the recorded region to a reflected light level from the unrecorded region. Moreover, when the optical beam is split into a main beam and one sub beam, and the one sub beam converges on an unrecorded region side where information is not recorded when the main beam is converged at the center of the track, the focus loss-of-control state or the tracking loss-of-control state is detected when the level of the signal from the sub beam receiving unit changes from a reflected light level from the unrecorded region to a reflected light level from the recorded region.

Accordingly, the focus loss-of-control state or the tracking loss-of-control state can be easily detected based on the change in the reflected light level of the sub beam.

Moreover, in the foregoing optical information device, preferably, the loss-of-control detection unit detects the focus loss-of-control state or the tracking loss-of-control state when a modulation degree of a signal output from the sub beam receiving unit is a modulation degree in a recorded region where information is recorded or a modulation degree in an unrecorded region where information is not recorded.

According to the foregoing configuration, the focus loss-of-control state or the tracking loss-of-control state is detected when a modulation degree of a signal output from the sub beam receiving unit is a modulation degree in a recorded region where information is recorded or a modulation degree in an unrecorded region where information is not recorded.

Accordingly, the focus loss-of-control state or the tracking loss-of-control state can be easily detected by the modulation degree of the signal output from the sub beam receiving unit being compared with the modulation degree in the recorded region or the modulation degree in the unrecorded region.

Moreover, in the foregoing optical information device, preferably, the sub beam includes a plurality of sub beams, the sub beam receiving unit includes a plurality of sub beam receiving units which respectively receive the plurality of sub beams reflected off the information layer, and loss-of-control detection unit detects the focus loss-of-control state or the tracking loss-of-control state when a sum of modulation degrees of a plurality of signals output from the plurality of sub beam receiving units is a modulation degree in a recorded region where information is recorded or a modulation degree in an unrecorded region where information is not recorded.

According to the foregoing configuration, the sub beam includes a plurality of sub beams. The plurality of sub beam receiving units respectively receive the plurality of sub beams reflected off the information layer. In addition, the focus loss-of-control state or the tracking loss-of-control state is detected when a sum of modulation degrees of a plurality of signals output from the plurality of sub beam receiving units is a modulation degree in a recorded region where information is recorded or a modulation degree in an unrecorded region where information is not recorded.

Accordingly, the focus loss-of-control state or the tracking loss-of-control state can be easily detected by the sum of modulation degrees of a plurality of signals output from the plurality of sub beam receiving units being compared with the modulation degree in the recorded region or the modulation degree in the unrecorded region.

Moreover, in the foregoing optical information device, preferably, the plurality of sub beams include a first sub beam which converges on a recorded region side where information is recorded when the main beam is converged at a center of the track, and a second sub beam which converges on an unrecorded region side where information is not recorded when the main beam is converged at the center of the track.

According to the foregoing configuration, the sub beams include a first sub beam which converges on a recorded region side where information is recorded when the main beam is converged at a center of the track, and a second sub beam which converges on an unrecorded region side where information is not recorded when the main beam is converged at the center of the track.

Accordingly, the focus loss-of-control state or the tracking loss-of-control state can be reliably detected by using the first sub beam reflected off the information layer and the second sub beam reflected off the information layer.

Moreover, in the foregoing optical information device, preferably, the loss-of-control detection unit detects the focus loss-of-control state or the tracking loss-of-control state when a modulation degree of a signal from the sub beam receiving unit changes from a modulation degree in a recorded region where information is recorded to a modulation degree in an unrecorded region where information is not recorded, or when the modulation degree of the signal changes from a modulation degree in the unrecorded region to a modulation degree in the recorded region.

According to the foregoing configuration, when the optical beam is split into a main beam and one sub beam, and the one sub beam converges on a recorded region side where information is recorded when the main beam is converged at the center of the track, the focus loss-of-control state or the tracking loss-of-control state is detected when a modulation degree of the signal from the sub beam receiving unit changes from a modulation degree in the recorded region to a modulation degree in the unrecorded region. Moreover, when the optical beam is split into a main beam and one sub beam, and the one sub beam converges on an unrecorded region side where information is not recorded when the main beam is converged at the center of the track, the focus loss-of-control state or the tracking loss-of-control state is detected when a modulation degree of the signal from the sub beam receiving unit changes from a modulation degree in the unrecorded region to a modulation degree in the recorded region.

Accordingly, the focus loss-of-control state or the tracking loss-of-control state can be easily detected based on the change in the modulation degree of the sub beam.

Moreover, in the foregoing optical information device, preferably, the sub beam includes a plurality of sub beams, the sub beam receiving unit includes a plurality of sub beam receiving units which respectively receive the plurality of sub beams reflected off the information layer, and the loss-of-control detection unit detects the focus loss-of-control state or the tracking loss-of-control state when a difference in levels of a plurality of signals output from the plurality of sub beam receiving units is less than a predetermined level.

According to the foregoing configuration, the sub beam includes a plurality of sub beams. The plurality of sub beam receiving units respectively receive the plurality of sub beams reflected off the information layer. The loss-of-control detection unit detects the focus loss-of-control state or the tracking loss-of-control state when a difference in levels of a plurality of signals output from the plurality of sub beam receiving units is less than a predetermined level.

Accordingly, since the focus loss-of-control state or the tracking loss-of-control state is detected when the difference in levels of a plurality of signals is less than a predetermined level, the focus loss-of-control state or the tracking loss-of-control state can be reliably detected.

Moreover, in the foregoing optical information device, preferably, the plurality of sub beams include a first sub beam which converges on a recorded region side where information is recorded when the main beam is converged at a center of the track, and a second sub beam which converges on an unrecorded region side where information is not recorded when the main beam is converged at the center of the track.

According to the foregoing configuration, the plurality of sub beams include a first sub beam which converges on a recorded region side where information is recorded when the main beam is converged at a center of the track, and a second sub beam which converges on an unrecorded region side where information is not recorded when the main beam is converged at the center of the track.

Accordingly, the focus loss-of-control state or the tracking loss-of-control state can be reliably detected by using the first sub beam reflected off the information layer and the second sub beam reflected off the information layer.

The loss-of-control detection method according to another aspect of the present invention is a loss-of-control detection method in an optical information device which records information by converging a main beam and a sub beam on an information layer of an information recording medium, the method comprising a focus control step of performing control so that a convergent point of the main beam converges on a predetermined information layer, a tracking control step of performing control so that a convergent point of the main beam scans a predetermined track or a predetermined mark sequence on an information layer, a sub beam receiving step of receiving the sub beam reflected off the information layer and outputting a signal according to an amount of beam received, and a loss-of-control detection step of detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal output in the sub beam receiving step.

According to the foregoing configuration, in the focus controlling step, control is performed so that a convergent point of the main beam converges on a predetermined information layer. In the tracking controlling step, control is performed so that a convergent point of the main beam scans a predetermined track or a predetermined mark sequence on an information layer. In the sub beam receiving step, the sub beam reflected off the information layer is received and a signal according to an amount of beam received is output. In the loss-of-control detecting step, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer is detected, based on a signal output in the sub beam receiving step.

Accordingly, since the focus loss-of-control state or the tracking loss-of-control state is detected, it is possible to prevent previously recorded information from being erroneously destroyed and prevent the mark sequence to be recorded from becoming discontinuous and, consequently, the recording reliability of the optical information device can be improved.

The optical information device according to another aspect of the present invention is an optical information device which records information on an information recording medium including a track in which mutually isolated recording regions are disposed in sequence, the device comprising a recording unit for recording information in each of the recording regions, a resonance element of which resonance state changes according to a recording condition of the recording region, a tracking control unit for performing control so that the recording unit scans a predetermined track, a resonance state detection unit for detecting a change in the resonance state of the resonance element occurring according to the recording condition of the recording region, and outputting a signal according to the detected change in the resonance state, and a loss-of-control detection unit for detecting, during a recording operation of recording the information, a tracking loss-of-control state where the recording unit deviates from the predetermined track, based on a signal from the resonance state detection unit.

According to the foregoing configuration, the recording unit records information in the recording region. The resonance element changes a resonance state according to a recording condition of the recording region. The tracking control unit performs control so that the recording unit scans a predetermined track. The resonance state detection unit detects a change in the resonance state of the resonance element occurring according to the recording condition of the recording region, and outputs a signal according to the detected change in the resonance state. The loss-of-control detection unit detects, during a recording operation of recording the information, a tracking loss-of-control state where the recording unit deviates from the predetermined track, based on a signal from the resonance state detection unit.

Accordingly, since the tracking loss-of-control state is detected, it is possible to prevent previously recorded information from being erroneously destroyed and prevent the mark sequence to be recorded from becoming discontinuous and, consequently, the recording reliability of the optical information device can be improved.

Moreover, in the foregoing optical information device, preferably, the resonance element includes a first resonance element, and a second resonance element disposed at a position that is different from the first resonance element, the resonance state detection unit includes a first resonance state detection unit for detecting a change in a resonance state of the first resonance element occurring according to the recording condition of the recording region and outputting a signal according to the detected change in the resonance state, and a second resonance state detection unit for detecting a change in a resonance state of the second resonance element occurring according to the recording condition of the recording region and outputting a signal according to the detected change in the resonance state, and the loss-of-control detection unit detects the tracking loss-of-control state when a difference between a level of the signal output from the first resonance state detection unit and a level of the signal output from the second resonance state detection unit is less than a predetermined level.

According to the foregoing configuration, the resonance element includes a first resonance element, and a second resonance element disposed at a position that is different from the first resonance element. The first resonance state detection unit detects a change in a resonance state of the first resonance element occurring according to the recording condition of the recording region and outputs a signal according to the detected change in the resonance state. The second resonance state detection unit detects a change in a resonance state of the second resonance element occurring according to the recording condition of the recording region and outputs a signal according to the detected change in the resonance state. The loss-of-control detection unit detects the tracking loss-of-control state when a difference between a level of the signal output from the first resonance state detection unit and a level of the signal output from the second resonance state detection unit is less than a predetermined level.

Accordingly, since the tracking loss-of-control state is detected when the difference between a level of a signal output from the first resonance state detection unit and a level of a signal output from the second resonance state detection unit is less than a predetermined level, the tracking loss-of-control state can be reliably detected.

The loss-of-control detection method according to another aspect of the present invention is a loss-of-control detection method in an optical information device which records information on an information recording medium including a track in which mutually isolated recording regions are disposed in sequence, the method comprising a tracking control step of performing control so that a recording unit for recording information in each of the recording regions scans a predetermined track, a resonance state detection step of detecting a change in a resonance state of a resonance element of which resonance state changes according to a recording condition of the recording region, and outputting a signal according to the detected change in the resonance state, and a loss-of-control detection step of detecting, during a recording operation of recording the information, a tracking loss-of-control state where the recording unit deviates from the predetermined track, based on a signal output in the resonance state detection step.

According to the foregoing configuration, in the tracking controlling step, control is performed so that a recording unit for recording information in each of the recording regions scans a predetermined track. In the resonance state detecting step, the change in the resonance state of the resonance element of which resonance state changes according to the recording condition of the recording region is detected, and a signal according to the detected change in the resonance state is output. In the loss-of-control detecting step, during a recording operation of recording the information, a tracking loss-of-control state where the recording unit deviates from the predetermined track is detected based on a signal output in the resonance state detection unit.

Accordingly, since the tracking loss-of-control state is detected, it is possible to prevent previously recorded information from being erroneously destroyed and prevent the mark sequence to be recorded from becoming discontinuous and, consequently, the recording reliability of the optical information device can be improved.

Note that the specific embodiments and examples described in the section of Description of Embodiments are first and foremost for clarifying the technical contents of the present invention, and the present invention should not be narrowly interpreted by being limited such specific examples, and the present invention may be variously modified and implemented within the scope of the spirit and claims of the present invention.

### INDUSTRIAL APPLICABILITY

The optical information device and the loss-of-control detection method according to the present invention can prevent previously recorded information from being erroneously destroyed and prevent the mark sequence to be recorded from becoming discontinuous, and are can be suitably applied to an optical information device and a loss-of-control detection method for recording information by converging a main beam and a sub beam on an information layer of an information recording medium. Accordingly, the present invention can be applied to large-capacity optical disc recorders and computer memory devices, which are examples of the applied equipment of an optical information device.

1-15. (canceled)

16. An optical information device which records information by converging a main beam and a sub beam on an information layer of an information recording medium, the device comprising:
a focus control unit for performing control so that a convergent point of the main beam converges on a predetermined information layer;
a tracking control unit for performing control so that the convergent point of the main beam scans a predetermined track or a predetermined mark sequence on an information layer;
a sub beam receiving unit for receiving the sub beam reflected off the information layer and outputting a signal according to an amount of beam received; and
a loss-of-control detection unit for detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal from the sub beam receiving unit,
wherein the sub beam includes a plurality of sub beams,
the sub beam receiving unit includes a plurality of sub beam receiving units which respectively receive the plurality of sub beams reflected off the information layer, and
the loss-of-control detection unit detects the focus loss-of-control state or the tracking loss-of-control state when a sum of levels of a plurality of signals output from the plurality of sub beam receiving units is a reflected light level from a recorded region where information is recorded or a reflected light level from an unrecorded region where information is not recorded.

17. The optical information device according to claim 16,
wherein the plurality of sub beams include a first sub beam which converges on a recorded region side where information is recorded when the main beam is converged at a center of the track, and a second sub beam which converges on an unrecorded region side where information is not recorded when the main beam is converged at the center of the track.

18. A loss-of-control detection method in an optical information device which records information by converging a main beam and a sub beam on an information layer of an information recording medium, the method comprising:
a focus control step of performing control so that a convergent point of the main beam converges on a predetermined information layer;
a tracking control step of performing control so that a convergent point of the main beam scans a predetermined track or a predetermined mark sequence on an information layer;
a sub beam receiving step of receiving the sub beam reflected off the information layer and outputting a signal according to an amount of beam received; and
a loss-of-control detection step of detecting, during a recording operation of recording the information, a focus loss-of-control state where the convergent point of the main beam deviates from the predetermined information layer or a tracking loss-of-control state where the convergent point of the main beam deviates from the predetermined track or the predetermined mark sequence on the information layer, based on a signal output in the sub beam receiving step,
wherein the sub beam includes a plurality of sub beams,
in the sub beam receiving step, the plurality of sub beams reflected off the information layer are respectively received by a plurality of sub beam receiving units, and
in the loss-of-control detecting step, the focus loss-of-control state or the tracking loss-of-control state is detected when a sum of levels of a plurality of signals output from the plurality of sub beam receiving units is a reflected light level from a recorded region where information is recorded or a reflected light level from an unrecorded region where information is not recorded.

19. An optical information device which records information on an information recording medium including a track in which mutually isolated recording regions are disposed in sequence, the device comprising:
a recording unit for recording information in each of the recording regions;
a resonance element of which resonance state changes according to a recording condition of the recording region;
a tracking control unit for performing control so that the recording unit scans a predetermined track;
a resonance state detection unit for detecting a change in the resonance state of the resonance element occurring according to the recording condition of the recording region, and outputting a signal according to the detected change in the resonance state; and
a loss-of-control detection unit for detecting, during a recording operation of recording the information, a tracking loss-of-control state where the recording unit deviates from the predetermined track, based on a signal from the resonance state detection unit.

20. The optical information device according to claim 19,
wherein the resonance element includes a first resonance element, and a second resonance element disposed at a position that is different from the first resonance element,
the resonance state detection unit includes a first resonance state detection unit for detecting a change in a resonance state of the first resonance element occurring according to the recording condition of the recording region and outputting a signal according to the detected change in the resonance state, and a second resonance state detection unit for detecting a change in a resonance state of the second resonance element occurring according to the recording condition of the recording region and outputting a signal according to the detected change in the resonance state, and
the loss-of-control detection unit detects the tracking loss-of-control state when a difference between a level of the signal output from the first resonance state detection unit and a level of the signal output from the second resonance state detection unit is less than a predetermined level.

21. A loss-of-control detection method in an optical information device which records information on an information recording medium including a track in which mutually isolated recording regions are disposed in sequence, the method comprising:
a tracking control step of performing control so that a recording unit for recording information in each of the recording regions scans a predetermined track;
a resonance state detection step of detecting a change in a resonance state of a resonance element of which resonance state changes according to a recording condition of the recording region, and outputting a signal according to the detected change in the resonance state; and
a loss-of-control detection step of detecting, during a recording operation of recording the information, a tracking loss-of-control state where the recording unit deviates from the predetermined track, based on a signal output in the resonance state detection step.
